(19) United States
(12) Patent Application Publication
(10) Pub. No.: US 2025/0028970 A1
(43) Pub. Date: Jan. 23, 2025

(54) BLOCKCHAIN-BASED FEDERATED LEARNING DEVICE, METHOD AND SYSTEM

(71) Applicant: ASIAINFO TECHNOLOGIES (CHINA), INC., HAIDIAN, BEIJING (CN)

(72) Inventors: Limeng MA, HAIDIAN, BEIJING (CN); Da WANG, HAIDIAN, BEIJING (CN); Aidong YANG, HAIDIAN, BEIJING (CN); Ye OUYANG, HAIDIAN, BEIJING (CN)

(73) Assignee: ASIAINFO TECHNOLOGIES (CHINA), INC., HAIDIAN, BEIJING (CN)

(21) Appl. No.: 18/279,186

(22) PCT Filed: Jun. 24, 2022
(86) PCT No.: PCT/CN2022/101201

§ 371 Date: Aug. 28, 2023

(51) Int. Cl. G06N 3/098; H04L 9/00

(52) U.S. Cl. CPC G06N 3/098; H04L 9/50

(57) ABSTRACT

The present disclosure relates to a blockchain-based federated learning device, method and system. An electronic device for the blockchain-based federated learning is proposed, including a processing circuit configured to acquire first federated learning related information from a federated learning node, cause verifying whether the federated learning node is able to participate in federated learning based on the first federated learning related information through blockchain, and notify the federated learning side of indication information indicating federated learning nodes that are able to participate in federated learning, so that the indicated federated learning nodes that can participate in federated learning can perform data processing based on federated learning.

### FIELD OF THE INVENTION

The present disclosure relates to a field of data processing, in particular to data processing based on federated learning.

### BACKGROUND

In recent years, artificial intelligence technology has developed rapidly and has been widely used in all walks of life, and with the help of being driven by a big data environment, artificial intelligence has entered a golden period of development. However, at present, there are still some potential problems in artificial intelligence technology driven by big data that need to be faced and solved: First, the problem of data sources, including limited data amount and data quality. In many industries, data exists in the form of data islands, and there are many obstacles to the integration of data between industries and even within industries. The second problem relates to data privacy and data security. How to effectively integrate and utilize data while ensuring data privacy and security is a difficult problem that has to be faced at present. For these two problems, Federated Learning has been proposed, which can help many organizations to conduct data usage, learn modeling and so on while meeting the requirements of user privacy protection, data security and government regulations.

With further improvement of requirements for security and accuracy, it is necessary to propose an improved federated learning framework.

Unless otherwise stated, it should not be assumed that any of the methods described in this section are prior art simply by being included in this section. Also, unless otherwise stated, issues recognized with respect to one or more methods should not be assumed as being recognized in any prior art on the basis of this section.

### DISCLOSURE OF THE INVENTION

The present disclosure proposes an improved federated learning method, in which federated learning is realized based on the blockchain, and in particular, participants and/or data processing of federated learning are optimized by using the blockchain, so that at least one of security, reliability and accuracy of federated learning can be improved.

One aspect of the present disclosure relates to an electronic device for blockchain-based federated learning, including a processing circuit configured to: acquire first federated learning related information from a federated learning node, cause verifying whether the federated learning node can participate in federated learning based on the first federated learning related information through blockchain, and notify the federated learning side of indication information indicating federated learning nodes that can participate in federated learning, so that the indicated federated learning nodes that can participate in federated learning can perform data processing based on federated learning.

Another aspect of the present disclosure relates to an electronic device for blockchain-based federated learning, including a processing circuit configured to: transmit first federated learning related information to a blockchain side, acquire indication information from the blockchain side indicating whether a federated learning node associated with the electronic device can participate in federated learning, wherein the indication information is generated by verifying the federated learning related information through blockchain, and under the condition that it is determined that the federated learning node associated with the electronic device can participate in federated learning based on the indication information, cause model optimization by federated learning nodes on the federated learning side that can participate in the federated learning in combination based on federated learning.

Yet another aspect of the present disclosure relates to a blockchain-based federated learning method, which is executed in a blockchain-based federated learning system, the system including a federated learning side and a blockchain side, and the method includes: transmitting first federated learning related information associated with a federated learning node to the blockchain side from the federated learning side, receiving the first federated learning related information and verifying whether a federated learning node can participate in federated learning based on the first federated learning related information through a blockchain, by the blockchain side; notifying the federated learning side of indication information indicating federated learning participant nodes that can participate in the federated learning by the blockchain side, determining, by the federated learning side, federated learning participant nodes based on the indication information, and wherein model optimization is performed by federated learning nodes in the federated learning side that can participate in federated learning based on federated learning.

Yet another aspect of the present disclosure relates to a method of blockchain-based federated learning, comprising acquiring first federated learning related information from a federated learning node, verifying whether the federated learning node can participate in federated learning based on the first federated learning related information through blockchain, and notifying the federated learning side of indication information indicating federated learning nodes that can participate in federated learning, so that the indicated federated learning nodes that can participate in federated learning can perform model optimization based on federated learning.

Another aspect of the present disclosure relates to a method of blockchain-based federated learning, comprising transmitting first federated learning related information to a blockchain side, acquiring indication information from the blockchain side indicating whether a federated learning node associated with the electronic device can participate in federated learning, wherein the indication information is generated by verifying the federated learning related information through blockchain, and under the condition that it is determined that the federated learning node associated with the electronic device can participate in federated learning based on the indication information, causing model optimization by federated learning nodes on the federated learning side that can participate in the federated learning in combination based on federated learning.

Yet another aspect of the present disclosure relates to a non-transitory computer-readable storage medium storing executable instructions that, upon executed, implement the method according to embodiments of the present disclosure as described in the context of the present specification.

Yet another aspect of the present disclosure relates to a device which includes a processor and a storage device, and the storage device stores executable instructions that, upon executed, implement the method according to embodiments of the present disclosure as described in the context of the present specification.

Yet another aspect of the present disclosure relates to a computer program containing instructions that, upon executed by a processor, cause the processor to implement the method according to embodiments of the present disclosure as described in the context of the present specification.

Yet another aspect of the present disclosure relates to a computer program product containing instructions that, upon executed by a processor, cause the processor to implement the method according to embodiments of the present disclosure as described in the context of the present specification.

Yet another aspect of the present disclosure relates to an apparatus comprising means for implementing the method according to embodiments of the present disclosure as described in the context of the present specification.

This section is provided to introduce some concepts in a simplified form that will be further described below in the detailed description. This section is not intended to identify key features or essential features of the claimed subject matter, nor is it intended to be used to limit the scope of the claimed subject matter. Other aspects and advantages of the technology will become apparent from the following detailed description of the embodiments and the accompanying drawings.

### DESCRIPTION OF THE DRAWINGS

The above and other objects and advantages of the present disclosure will be further described below with reference to specific embodiments and with reference to the drawings. In the drawings, the same or corresponding technical features or components will be denoted by the same or corresponding reference symbols.

FIG. 1A shows a basic block diagram of a concept of blockchain-based federated learning according to the present disclosure, and FIG. 1B shows a schematic signaling diagram of the concept of blockchain-based federated learning according to the present disclosure.

FIG. 2A shows a block diagram of a first type of architecture of blockchain-based federated learning according to an embodiment of the present disclosure, and FIG. 2B shows a block diagram of a second type of architecture of blockchain-based federated learning according to an embodiment of the present disclosure.

FIG. 3A shows a schematic block diagram of a blockchain-side electronic device for blockchain-based federated learning according to the present disclosure. FIG. 3B shows a schematic flowchart of a blockchain-side method of blockchain-based federated learning according to the present disclosure.

FIG. 4A shows a schematic block diagram of a federated learning side electronic device for blockchain-based federated learning according to the present disclosure. FIG. 4B shows a schematic flowchart of a federated learning side method of blockchain-based federated learning according to the present disclosure.

FIG. 5A shows a flowchart of a method of blockchain-based federated learning according to an embodiment of the present disclosure. FIG. 5B shows an overall signaling diagram of blockchain-based federated learning according to an embodiment of the present disclosure.

FIG. 6A shows an architecture diagram of blockchain-based federated learning according to the first embodiment of the present disclosure. FIG. 6B shows a flowchart of blockchain-based federated learning according to the first embodiment of the present disclosure. FIG. 6C shows a signaling diagram of blockchain-based federated learning according to the first embodiment of the present disclosure.

FIG. 7A shows an architecture diagram of blockchain-based federated learning according to a second embodiment of the present disclosure. FIG. 7B shows a flowchart of blockchain-based federated learning according to a second embodiment of the present disclosure. FIG. 7C shows a signaling diagram of blockchain-based federated learning according to a second embodiment of the present disclosure.

FIG. 8A shows an architecture diagram of blockchain-based federated learning according to a third embodiment of the present disclosure. FIG. 8B shows a flowchart of blockchain-based federated learning according to a third embodiment of the present disclosure. FIG. 8C shows a signaling diagram of blockchain-based federated learning according to a third embodiment of the present disclosure.

FIG. 9A shows an architecture diagram of blockchain-based federated learning according to a fourth embodiment of the present disclosure. FIG. 9B shows a flowchart of blockchain-based federated learning according to a fourth embodiment of the present disclosure. FIG. 9C shows a signaling diagram of blockchain-based federated learning according to a fourth embodiment of the present disclosure.

FIG. 10A shows an architecture diagram of blockchain-based federated learning according to a fifth embodiment of the present disclosure. FIG. 10B shows a flowchart of blockchain-based federated learning according to a fifth embodiment of the present disclosure. FIG. 10C shows a signaling diagram of blockchain-based federated learning according to a fifth embodiment of the present disclosure.

FIG. 11A shows an architecture diagram of blockchain-based federated learning according to a sixth embodiment of the present disclosure. FIG. 11B shows a flowchart of blockchain-based federated learning according to a sixth embodiment of the present disclosure. FIG. 11C shows a signaling diagram of blockchain-based federated learning according to a sixth embodiment of the present disclosure.

FIG. 12 illustrates an outline of a computer system in which embodiments according to the present disclosure may be implemented.

It should be noted that in order to avoid obscuring the present disclosure with unnecessary details, only the processing steps and/or equipment structures closely related to at least the scheme according to the present disclosure are shown in the attached drawings, and other details that have little to do with the present disclosure are omitted.

### DETAILED DESCRIPTION OF PREFERRED EMBODIMENTS

Hereinafter, exemplary embodiments of the present disclosure will be described with reference to the accompanying drawings. For clarity and conciseness, not all features of an embodiment are described in the specification. However, it should be understood that many implementation-specific settings must be made during the implementation of the embodiment in order to achieve specific goals of the developer, for example, to meet those restrictions related to equipment and business which may change depending on the implementation. In addition, it should also be understood that, although development work may be very complex and time-consuming, it is only a routine task for those skilled in the art benefiting from this disclosure.

Here, it should be understood, however, that the drawings and detailed description thereof are not intended to limit the embodiments to the disclosed particular forms, but rather, the intention is to cover all modifications, equivalents, and alternatives falling within the spirit and scope of the scheme of the present disclosure. And the embodiments described in the present disclosure further comprise various modification and alternative forms.

In this specification, reference to “one embodiment” or “an embodiment” means that one or more features involved are included in at least one embodiment of the present disclosure. In particular, separate references to “one embodiment” or “an embodiment” in this specification do not necessarily refer to the same embodiment, and are not mutually exclusive, unless so stated and/or obvious to those skilled in the art. For example, features, structures, actions, etc. described in one embodiment may be, but not necessarily, included in other embodiments. Therefore, the technical solution of the present disclosure may include various combinations and/or integrations of embodiments described herein.

Federated learning belongs to an artificial intelligence technology, and defines a machine learning framework, under this framework, a virtual model can be designed to solve a problem that different data owners can cooperate without exchanging data. Virtual model is the best model for all parties to aggregate data. Federated learning requires that this modeling result should be as close as possible to a traditional model, that is, the result that data of multiple data owners are gathered for modeling. In federated learning, each participant or entity (also called data owner) or client or coordinator can cooperate to perform data processing, such as model training and model application, etc. Moreover, in federated learning, each participant does not need to expose data to other participants or coordinators, such as various servers.

In particular, federated learning is especially suitable for data joint training based on different data sources. Federated learning framework can usually be realized as a distributed model training framework, in which multiple participants can carry out machine learning model training under the condition that data privacy protection meets legal and compliance requirements, thus solving the problem of data islands, and the model obtained through federated learning training can be better than that trained by any participant alone based on its own data.

Nowadays, federated learning faces some challenges. On the one hand, it involves the mutual trust among participant users. Because the participants in federated learning come from different organizations or institutions and lack trust with each other. How to establish a safe and reliable cooperation mechanism in the absence of mutual trust is an urgent problem in practical application. On the other hand, there lacks corresponding quality verification mechanisms for the data and parameters provided by the participants. Malicious participant users may provide false model parameters to undermine the learning process. Still on the other hand, the privacy of data and parameters in the process of processing, transmission and storage needs to be further protected and strengthened.

Blockchain network belongs to an intelligent peer-to-peer network that identifies, propagates and records information through distributed databases. In the blockchain network, there is no core node, and all nodes follow established rules, such as consensus mechanism. The consensus mechanism on the blockchain mainly solves the problem of who will construct the blockchain and how to maintain the unity of the blockchain. Compared with the traditional network, blockchain has two core characteristics: one is that data is difficult to tamper with, and the other is decentralization. Based on such two characteristics, the information recorded by blockchain is more real and reliable.

Blockchain can be divided into public chain, alliance chain and private chain according to different ways of members joining therein. Public chain means a blockchain where anyone in the world can read and transmit transactions, where the transactions can be effectively confirmed, and can also participate in the consensus process. Alliance chain actually means a cluster composed of multiple private chains, and a blockchain managed jointly by multiple institutions. Each organization or institution manages one or more nodes, and only different institutions in the system are allowed to read, write and transmit the data in the chain. Each node in the alliance chain usually has a corresponding entity organization, and can join and exit the network only after authorization. All institutions and organizations form a stakeholder alliance to jointly safeguard the healthy operation of the blockchain. Private chain means a blockchain whose write permission is completely controlled by an organization, and its public degree is determined by the organization, and all nodes participating in this blockchain will be strictly controlled.

In view of this, the present disclosure proposes an improved federated learning mechanism, especially a federated learning mechanism based on blockchain. The blockchain provides a credible mechanism for all participants (users) in federated learning, in which various processes in the federated learning process, including but not limited to participant verification, data processing, data transmission, data storage, etc., are supported by blockchain technology (such as blockchain network), so that more secure, accurate and reliable federated learning can be realized. In this disclosure, the term “blockchain technology” includes, but not limited to, a technology such as distributed storage, peer-to-peer network, consensus mechanism, encryption algorithm, etc., and the term “consensus mechanism” usually refers to a mathematical algorithm for establishing trust and obtaining rights between different nodes in a blockchain system, which will not be described in detail here.

In particular, the present disclosure proposes a blockchain-based verification mechanism for federated learning, including, but not limited to, at least one of verifying initiation/startup of federated learning through blockchain, verifying participants of federated learning through blockchain, verifying security/credibility of federated learning application data through blockchain, etc., thereby improving the security and/or accuracy of federated learning.

In one aspect, participants in federated learning can be verified through blockchain. In particular, applicants who intend to participate in the federated learning are verified, so that the participants who are suitable for participating in the federated learning can be confirmed, and the credibility of the participants in the federated learning can be improved, so that the federated learning can be carried out safely and credibly, and the credibility of the federated learning can be improved.

On the other hand, additionally or alternatively, the federated learning application data can be verified through blockchain, and the federated learning application data includes data generated by local processing of federated learning participant applying its own data. In particular, the reliability and safety of such data can be verified, so that unreliable, unsafe, and even abnormal data can be discarded, so that more accurate data can be obtained for federated learning applications and the accuracy of federated learning can be improved.

In yet another aspect, additionally or alternatively, it is possible to verify whether to initiate/start federated learning through blockchain. In particular, the verification is performed based on the information contained in the federated learning initiation request, and if the verification passes, the federated learning is initiated, so that invalid or even malicious federated learning applications can be avoided, and the efficiency and reliability of federated learning can be improved.

Moreover, various operations in the federated learning process can be implemented and deposited on the blockchain, for example, various verification operations, computation operations, data transmission, etc. according to embodiments of the present disclosure are all realized through blockchain, so that they can be permanently stored and cannot be tampered with. This improves the security auditability and traceability between transactions and enhances the security and privacy.

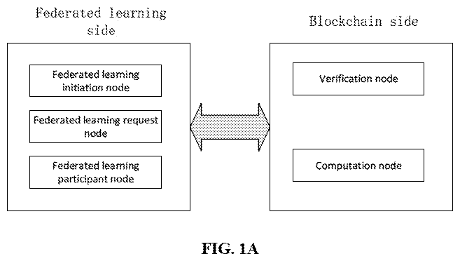

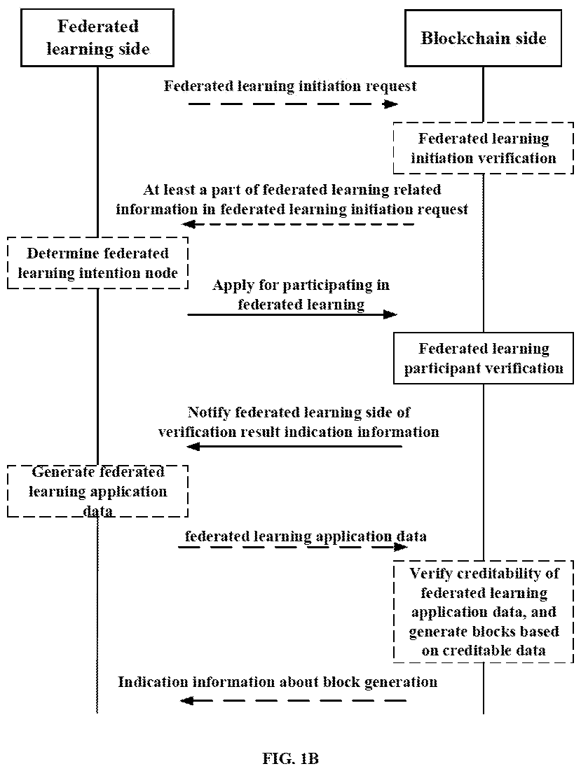

The basic concept of the blockchain-based federated learning according to the present disclosure will be described below with reference to the accompanying drawings. FIG. 1A shows an exemplary system architecture that can realize the basic idea according to an embodiment of the present disclosure. The system architecture is an architecture in which blockchain and federated learning are combined with each other, which can include a federated learning side and a blockchain side, and they can communicate with each other through various appropriate communication technologies, for example, wireless communication technologies such as 4G, 5G and even future communication technologies. It should be pointed out that the federated learning side and the blockchain side mentioned here are only for convenience of description, instead of limiting any implementation of the system architecture.

The federated learning side indicates a collection of various nodes (which can also be called units, etc.) that can be used for federated learning. The federated learning side usually contains more than two nodes. Nodes can be implemented in various ways, such as physical implementation, virtual implementation, etc. The entity can be any suitable type of entity. For example, in the wireless communication application scenario, it can include various terminal devices, such as Internet of Things devices, intelligent mobile devices, user terminal devices and so on. The virtual implementation may be implemented by software, programs, etc. A plurality of nodes on the federated learning side can be set in any suitable way. They may be independent from each other, or come from different participants, organizations or institutions, and can perform communication without data, or even cannot communication directly. The federated learning side can also be called federated learning end, federated learning network, etc.

The blockchain side indicates a collection of various nodes (which can also be called units, etc.) to which the blockchain technology can be applied or which can lead to application of the blockchain technology. The blockchain side usually contains more than two nodes. Nodes can be implemented in various ways, such as physical implementation, virtual implementation, etc. The entity can comprise any suitable type of entity. For example, in the wireless communication application scenario, it can include various devices that can support the operation using blockchain technology, such as base stations, various network elements, MEC devices, etc. The virtual implementation may be implemented by software, programs, etc. A plurality of nodes on the blockchain side can form various appropriate types of blockchain networks, such as the above-mentioned public chain, alliance chain, private chain, and especially alliance chain. The blockchain side can also be called blockchain end, blockchain network, etc.

According to embodiments of the present disclosure, the nodes on the federated learning side may be called federated learning nodes, for example, which may include or serve as various types of nodes. In some embodiments, the federated learning node may include or serve as a federated learning intention node or a federated learning request node, which is usually a node that intends or attempts to participate in the federated learning, and may make a federated learning participation request to the blockchain side during the federated learning process, and participate in federated learning as a federated learning participation node after being confirmed to be able to participate in federated learning. In some embodiments, the federated learning node can also comprise or serve as a federated learning participant node, which generally indicates an entity that will actually participate in federated learning, which can be a node verified by the blockchain side to be allowed to participate in federated learning. In some embodiments, the federated learning node may also comprise or serve as a federated learning initiation node. As an example, a federated learning initiation node is an entity that wants or intends to launch the federated learning, for example, when a node wants to realize a certain business, application or service through federated learning, it can issue a federated learning initiation request to the blockchain side.

It should be pointed out that the expressions of the federated learning initiation node, the federated learning application node and the federated learning participation node are only for clearly explaining the concept of the present disclosure, instead of limiting their implementation forms. In particular, they don't have to be separated and different from each other, but they can also contain each other and even be converted into each other. For example, they can be configured according to at least one of functions, operations, states and the like in the federated learning process. For example, after the initiation of federated learning, the initiation node of federated learning usually belongs to the federated learning application node and the federated learning participation node. The federated learning application node can be converted into a federated learning participation node after being verified to be allowed to participate in federated learning. For example, in the process of federated learning, a federated learning node can be a federated learning application node, or a federated learning participation node, or even a federated learning initiation node. For example, federated learning initiation node, federated learning application node and federated learning participation node can be the corresponding names of a federated learning node at different stages and states in the federated learning process.

According to an embodiment of the present disclosure, the blockchain side may include a verification node for processing at least one of various verification operations implemented through blockchain according to the present disclosure. In particular, at least one request from the federated learning side can be verified through blockchain, for example, the federated learning participation request can be verified to determine whether the federated learning node issuing the request is allowed to participate in federated learning; or the federated learning initiation request can be verified to determine whether the federated learning is allowed to be initiated or started, or the federated learning application data submitted by federated learning participant nodes can be verified to ensure the security and reliability of such data.

According to embodiments of the present disclosure, the verification node can be implemented in various appropriate ways. In some embodiments, the verification node may cause a verification operation to be performed through blockchain. For example, it can be realized by an appropriate device outside the blockchain, so that the blockchain network or nodes therein can be controlled or triggered to perform the verification operation through blockchain. In some embodiments, the verification node itself may perform the verification operation, for example, it may be implemented by a node in a blockchain. As an example, federated learning verification nodes can be implemented by an appropriate number of blockchain nodes. For example, it can be realized by a single blockchain node, which can realize all the required verification operations, or it can be realized by two or more blockchain nodes. For example, verification operations can be performed by all parties in the blockchain, and then mutual verification can be performed in the blockchain network to ensure more accurate results.

In some embodiments, verification nodes can be configured correspondingly for various verification operations in the federated learning operation process, so that each verification operation is handled by a corresponding verification node. As an example, the verification nodes correspond to the aforementioned verification operations one by one, that is, correspond to the federated learning nodes associated with the verification operations one by one, and verify corresponding requests. As another example, verification nodes correspond to verification operations one-to-many, and for example, two or more verification operations according to the present disclosure may be handled by a single verification node. As another example, various verification operations in the federated learning operation process can all be passed by the verification node to the blockchain network (especially at least some or all nodes in the blockchain network) for handling.

According to the embodiment of the present disclosure, the verification nodes on the blockchain side can be statically configured. For example, the verification node can be preset, such as its corresponding relationship with various verification operations, the corresponding relationship between the verification node and the federated learning side node, etc. can be preset, for example, it can be set by the user, set according to the performance of the node, etc., and remain unchanged during the federated learning. In some embodiments, the verification nodes on the blockchain side can be dynamically configured, especially every time a verification operation request is received, for example, it can be dynamically specified according to the performances of the blockchain nodes, or it can be selected among entities on the blockchain side according to an appropriate blockchain technology, such as voting technology, consensus technology, etc.

According to the embodiment of the present disclosure, additionally or alternatively, the blockchain side may include nodes for processing computation operations related to the federated learning, which may include a specific number of blockchain nodes on the blockchain side, for example, all the blockchain nodes constituting a specific blockchain network. In some embodiments, the nodes can apply the blockchain technology to generate blocks based on the obtained federated learning application data, etc., and feed them back to the federated learning side. In this way, the processing flow of federated learning can be recorded and reflected through blockchain technology. It should be pointed out that this node and the aforementioned verification node are not necessarily separated and different from each other, but they can also contain each other and even be converted to each other. For example, they can be the same node and perform corresponding operations at different stages in the federated learning process. For example, they can be different names for a blockchain node.

It should be pointed out that the federated learning side and the blockchain side are not necessarily separated from each other, but there may exist at least partial overlap therebetween. In one example, some or even all nodes on the federated learning side can be nodes on the blockchain side, and in another example, some or even all nodes on the blockchain side can be nodes on the federated learning side. In particular, in some embodiments, in the case that the federated learning node can be included in the blockchain network, the verification node according to the present disclosure can also be any one of the federated learning nodes, as long as the federated learning node has sufficient ability to perform federated learning node verification. In some examples, the verification node may be a federated learning participant node or even a federated learning request node.

FIG. 1B shows a schematic signaling diagram of blockchain-based federated learning according to an embodiment of the present disclosure, in particular, the signaling interaction between the federated learning side and the blockchain side in the architecture of the federated learning system, which may include signaling interaction involving verification operations and computation operations according to the present disclosure.

On one hand, the operation according to the present disclosure may involve verification by the federated learning participants (which may be called the first verification operation), wherein the signaling interaction between the federated learning side and the blockchain side is as follows:

A federated learning node (also called a federated learning intention node) on the federated learning side transmits a request for joining federated learning to the blockchain side,

Upon receiving the request, the blockchain side (especially the verification node on the blockchain side) will verify whether the federated learning intention node is allowed to participate in the federated learning based on the federated learning related information contained in the request, and

Optionally, the blockchain side notifies the federated learning side of the verification result.

In this way, the participants of federated learning are verified through blockchain, and a safe and credible cooperation mechanism can be established. Especially, for federated learning of specific types, businesses and applications, participants who are suitable to and allowed to participate in such federated learning can be determined, so that these determined participants can cooperate with each other to conduct federated learning, and malicious participants can be prevented from participating in federated learning, thus improving the security of federated learning.

Here, the federated learning intention node may be a federated learning node on the federated learning side that is set or selected in any suitable way. In one implementation, it can be specified in advance for a specific type of federated learning, and it can automatically serve as an intention node when this type of federated learning starts, for example, when it is broadcasted, or notified by a control equipment, or notified in other appropriate ways to start the federated learning on the federated learning side. In another implementation, the federated learning node itself can determine whether it is to be an intention node. In particular, the federated learning node can confirm whether to participate in or is suitable to participate in the federated learning based on specific federated learning related information (which can be called second federated learning related information). For example, the similarity or matching between the federated learning node's own information and the second federated learning related information can be judged, and if it is judged to be similar or match, it will be confirmed that the federated learning node intends to participate in the federated learning, which will be described in detail below.

In some embodiments, the federated learning related information contained in the request sent by the federated learning intention node may be referred to as the first federated learning related information, which may include at least one of identity information representing the federated learning intention node, various information related to the federated learning model and data, etc. In particular, the first federated learning related information may include related information representing data used by the node to perform federated learning, related information indicating data generated when the node participates in the federated learning processing (for example, it may include federated learning application data), related information representing the federated learning model, etc. In particular, the aforementioned second federated learning related information may be or comprise information which is at least partially the same type as the first federated learning-related information.

In some embodiments, the blockchain side verifying whether the first federated learning related information meets the federated learning requirements can include at least one of identity verification, data verification, and so on, and can confirm that the federated learning application node can participate in federated learning if the first federated learning verification related information meets the federated learning requirements, and notify the federated learning node of the verification result. The blockchain side can transmit the verification results to the federated learning side in various appropriate ways. For example, the result can be broadcasted to the federated learning side, or can be transmitted to a specific federated learning node so as to be notified to the federated learning intention nodes that are allowed to participate in federated learning. It should be pointed out that that the verification result can be notified to the federated learning side at an appropriate time, for example, after the participate nodes are verified, or together with the processing results after subsequent processing is performed. For example, if the first federated learning related information contains federated learning application data for federated learning nodes, the blockchain side can directly employ the federated learning application data to perform subsequent processing, and then notify the federated learning side of the data together with the processing results.

On the other hand, additionally or alternatively, the operation according to the present disclosure may also involve the verification of federated learning application data (which may be referred to as a second verification operation), which may be performed after the first verification operation, in which signaling interaction between the federated learning side and the blockchain side is as follows:
Federated learning nodes (also referred to as federated learning participant nodes) transmit federated learning application data to the blockchain side,
The blockchain side (especially the verification nodes on the blockchain side) verifies the reliability or security of the received federated learning application data,
The blockchain side (especially the computation nodes on the blockchain side) generates blocks based on the verified federated learning application data; and
The blockchain side notifies the federated learning side of relevant information about block generation.

Therefore, during the federated learning, unreliable, unsafe, abnormal and even suspicious federated learning application data can be filtered out, which improves the accuracy and reliability of federated learning.

In the present disclosure, a federated learning participant node may be a federated learning node that is confirmed to be allowed to participate in federated learning based on the verification results of federated learning participants, as described above. Federated learning nodes can be determined in various suitable ways. As an example, it can be directly notified by the blockchain, or by a specific federated learning node or other device that acquires the verification result. As another example, the federated learning participant nodes may be determined by the federated learning nodes themselves. For example, the federated learning node may receive the verification result from the aforementioned federated learning participant, and judge whether its own is a federated learning participant node that is allowed to participate in federated learning based on the verification result. For example, IDs of the nodes in the verification result allowed to participate in federated learning is compared with its own identity information, and if matches, its own is considered to be allowed to participate in federated learning.

In this disclosure, each federated learning participant is responsible for its corresponding part of federated learning and can generate federated learning application data. The federated learning application data may include data generated by federated learning participants applying their own data (for example, through their own model, which may be a sub-part of the overall federated learning model) to local processing related to federated learning. The federated learning application data may include various information obtained or generated by applying a model when performing federated learning for a certain business, service, etc. in a specific application scenario. As an example, in the case where federated learning is used for model training, federated learning application data may correspond to parameter information about the model to be trained by federated learning, for example, including information related to the model parameters obtained by each federated learning participant node through local model training, such as at least one of model attributes, model characteristics and the like.

In this disclosure, the blockchain side can verify whether the federated learning application data is safe and reliable through various appropriate blockchain technologies, such as smart contracts, etc., so that it can identify and remove data, which is considered to be unsafe, unreliable, suspicious or abnormal, from the received federated learning application data, and obtain safe and reliable federated learning application data for federated learning.

In the present disclosure, the blockchain side can generate a block based on federated learning application data, which is verified to be safe or reliable, through blockchain. Various appropriate blockchain technologies that can be employed here can be various appropriate technologies, such as consensus algorithm in blockchain. Blocks generated on the blockchain side can be various types of blocks, such as sub-blocks, or a global block based on sub-blocks. In some embodiments, sub-blocks may be generated based on federated learning application data provided by a single or a specific number of federated learning participant nodes, and the generated sub-blocks may be combined to generate the global block.

In this disclosure, the blockchain side notifies the federated learning side of information related to block generation. In one example, the federated learning side can be notified of the block generation status, and particularly, the sub-block or global block generation status. For example, it can be directly notified to the federated learning side by broadcasting, or it can be indirectly notified, for example, notified to specific devices and nodes in the federated learning side and then relayed (for example, broadcasted) to all participant nodes in the federated learning side, or broadcasted to all nodes. In some embodiments, when the block-related information indicates the block generation status, the block, for example, the global block generated by the blockchain side or the sub-blocks generated by the blockchain side, can be acquired from the blockchain side, and then the global block can be generated at the federated learning side. In another example, if allowed, the generated sub-block data or global block data can be notified to the federated learning participant nodes, for example, by broadcasting, or indirect communication such as forwarding via a specific federated learning node, as described above.

In this way, the federated learning participant nodes can acquire the blocks generated by the blockchain side to realize federated learning. For example, in the case of applying federated learning to model training, blocks will be acquired and used for local model optimization.

It should be noted that the above-mentioned second verification operation is not necessary. Especially, in some scenarios, after verifying or determining the situations of federated learning participants as mentioned above, the verification results can be notified to federated learning participant nodes, so that federated learning participant nodes can directly cooperate with each other to conduct federated learning. This will be described in detail below.

In yet another aspect, additionally or alternatively, the operation according to the present disclosure may also involve a verification for federated learning initiation (which may be referred to as a third verification operation), which may be before the first verification operation, in which the signaling interaction between the federated learning side and the blockchain side is as follows:

The federated learning side (especially the federated learning initiation node) transmits a federated learning initiation request to the blockchain side,

The blockchain side (especially the federated learning verification node) verifies whether the federated learning is allowed to be initiated based on the federated learning related information contained in the federated learning initiation request, and

In the case that an appropriate federated learning is allowed to be initiated, the blockchain side notifies the federated learning side of at least a part of the federated learning related information.

Therefore, the blockchain side can allow the initiation of appropriate federated learning, avoid malicious initiation of federated learning, avoid invalid loss, and improve system reliability and security.

In the present disclosure, the federated learning-related information contained in the federated learning initiation request may be referred to as third federated learning-related information, which may be various appropriate information, and in particular, may comprise information which is at least partially the same type as the first federated learning-related information mentioned earlier, as described above.

In this disclosure, when verifying based on the third federated learning related information, the blockchain side can verify whether the federated learning related information meets the federated learning requirements, such as whether a federated learning initiation node is qualified to initiate federated learning, whether data indicated by the federated learning related information or model-related information is suitable for initiating or can initiate federated learning, and so on, and if the requirements are met, the federated learning is allowed to initiate.

In this disclosure, the blockchain side can notify the federated learning side of the federated learning related information in various appropriate ways, such as broadcasting. In particular, at least a part of the third federated learning related information (which can serve as the aforementioned second federated learning related information) can be notified to the blockchain side, as long as this part is enough for the federated learning node to judge whether it is willing to participate in federated learning. Therefore, each federated learning node judges whether it intends to participate in federated learning based on the at least part of the third federated learning related information, and if it judges that it intends to participate in federated learning, it will perform subsequent processing, such as the signaling interaction involving the verification operation of federated learning participants as mentioned above, as a federated learning intention node.

In the embodiment of the present disclosure, further, after the federated learning for an application/business/service is executed, whether the federated learning result meets the requirements can be verified, and if the requirements are met, the federated learning will be stopped, otherwise, the subsequent federated learning will continue to be iteratively performed, until the requirements are met.

In some embodiments, during the iterative federated learning process, the federated learning participant nodes may be static, for example, remain unchanged during the federated learning process. As an example, a federated learning participant node that is verified at the beginning of the first federated learning will always participate in federated learning. In other embodiments, in the iterative federated learning process, the federated learning participant nodes may be dynamic, for example, dynamically adjusted during the federated learning process. As an example, at the beginning of each iteration, the verification of the participant nodes and even the verification of the intention nodes can be performed as described above, and the verified federated learning participant nodes will participate in the federated learning of this iteration. In this way, more appropriate federated learning nodes can be selected for each iterative process of federated learning, thus realizing federated learning more appropriately and reliably.

In this way, by performing signaling interaction between the federated learning side and the blockchain side based on the blockchain as described above, safe and reliable interaction can be performed between the federated learning side and the blockchain side, which can help to realize safe and reliable federated learning.

In particular, the above-mentioned overall signaling interaction flow is particularly suitable for initiating and realizing federated learning for specific applications, services, and the like. Especially, when a node wants to conduct federated learning for a certain application, business or service, it will request the blockchain side to initiate federated learning, so that the blockchain side judge whether the federated learning is to be initiated, and if the federated learning can be initiated, the blockchain side will convene, find or assign participants or nodes of federated learning, so that these federated learning participants can cooperate with each other to form a federated learning network, thereby conducting federated learning. Among them, participating in various operations through a blockchain network during federated learning can realize safe, reliable and credible federated learning.

Hereinafter, a federated learning system architecture according to an embodiment of the present disclosure will be described with reference to the drawings. According to the embodiment of the present disclosure, two types of blockchain-based federated learning architectures are proposed according to deployment positions of federated learning participants and blockchain nodes. In the first type of architecture, the federated learning side is separated from the blockchain side, and the federated learning participants do not belong to the blockchain side. In the second type of architecture, the federated learning side at least partially or even completely overlaps with the blockchain side, and at least some of the federated learning participants belong to the blockchain nodes. According to the embodiment of the present disclosure, the communication between the federated learning side and the blockchain side can be performed in various appropriate ways, for example, various communication ways and various appropriate signals can be used for signaling, such as broadcasting and/or broadcast signals and/or dedicated signals on specific channels, for example, various appropriate wireless communication ways, such as 4G, 5G and other related communication technologies, and various appropriate wired communication ways such as optical fiber and broadband.

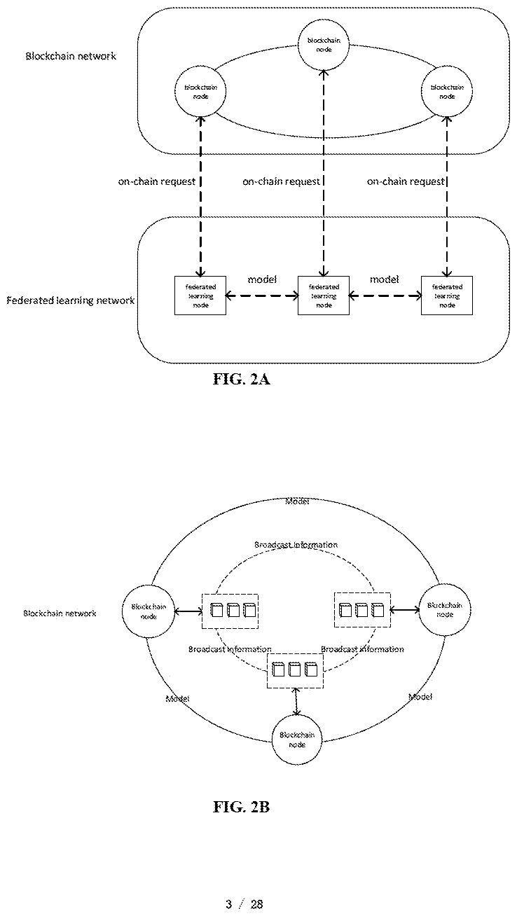

FIG. 2A shows the first type of architecture of blockchain-based federated learning according to the present disclosure. Such federated learning architecture can be considered as a hierarchical architecture, which can be divided into two layers according to functions. One layer is a collection of federated learning nodes, which can be expressed in various appropriate forms, such as a federated learning network composed of federated learning nodes, and the other layer is a collection of blockchain nodes, such as a blockchain network composed of blockchain nodes, such two layers can be referred to as an outer layer and an inner layer, or an upper layer and a lower layer, respectively. In this architecture, the federated learning network is located outside the blockchain, and the federated learning nodes can access the blockchain network through the corresponding blockchain nodes and conduct federated learning through blockchain nodes in the blockchain network. The blockchain nodes here may correspond to at least one of the aforementioned verification nodes, computation nodes, and the like. In this architecture, communication modes between different networks known in the field can be adopted between the blockchain layer and the federated learning layer, such as communication in the same type of network, communication between different types of networks, such as wireless communication modes based on 4G and 5G, and various appropriate wired communication modes, etc.

FIG. 2B shows a second type of architecture of blockchain-based federated learning according to the present disclosure, in which a federated learning network is included in a blockchain. In particular, in this architecture, the federated learning node and its corresponding blockchain node can be integrated, so that the federated learning node can also perform the federated learning process in the blockchain network as a blockchain node. As an example, the signaling interaction between the aforementioned federated learning side and the blockchain side can be directly converted into communication in the blockchain network, and the aforementioned operations of various federated learning nodes will be performed by the blockchain nodes through a blockchain network. For example, a federated learning initiation node as a blockchain node can directly broadcast the initiation request in the blockchain network, a federated learning intention node as a blockchain node will directly broadcast the participation request in the blockchain network, and federated learning participant nodes as blockchain nodes will form a federated learning network inside the blockchain network for data processing, for example, in the case of model training, a global model can be acquired (for example, generated) for model optimization. In this case, the nodes can communicate with each other in the blockchain network by the communication manner known in the field, such as notification by means of broadcasting. It should be pointed out that in this case, for the convenience of description, expressions such as blockchain side and federated learning side or similar expressions can still be used, but it should be pointed out that they are only different expressions of the same set of nodes.

It should be pointed out that FIGS. 2A and 2B are only exemplary, in particular, the number of federated learning nodes and blockchain nodes shown in FIGS. 2A and 2B, as well as the corresponding relationship between them are only exemplary. As an example, the number of federated learning nodes and blockchain nodes are not limited to the number shown in the figures, but may be more or less. In particular, the number of blockchain nodes is not particularly limited, as long as the blockchain technology can be applied for operation.

The implementation of the blockchain side of the blockchain-based federated learning according to the embodiment of the present disclosure will be described below with reference to the figures. It should be pointed out that the operation on the blockchain side according to the embodiment of the present disclosure can be realized by the electronic device on the blockchain side, which can be outside the blockchain and can control or trigger operations through blockchain (for example, via nodes in the blockchain); or it can be within the blockchain, for example, it may be either a blockchain node or a part of a blockchain node, such as its member, component, etc. In one implementation, the electronic device may correspond to at least one of the verification node or the computation node on the blockchain side as described above.

In addition, the implementation of the scheme of the present disclosure will be described below mainly for a scenario of model training based on federated learning, wherein the scheme of the present disclosure can be used to optimize the trained model, such as model parameters, based on federated learning. However, it should be pointed out that the scheme of the present invention can also be used in other application scenarios where federated learning can be utilized, such as implementing blockchain-based federated learning for a certain application, business, service, etc. In particular, participants can be screened, and the data in the application process can be screened with respect to reliability, so as to ensure the application quality and improve the application effect. Alternatively, in the application stage, the identity authentication of federated learning participants can be simplified. For example, the identity information of federated learning participants can be notified in advance, so that only the model application results from these federated learning participants can be received.

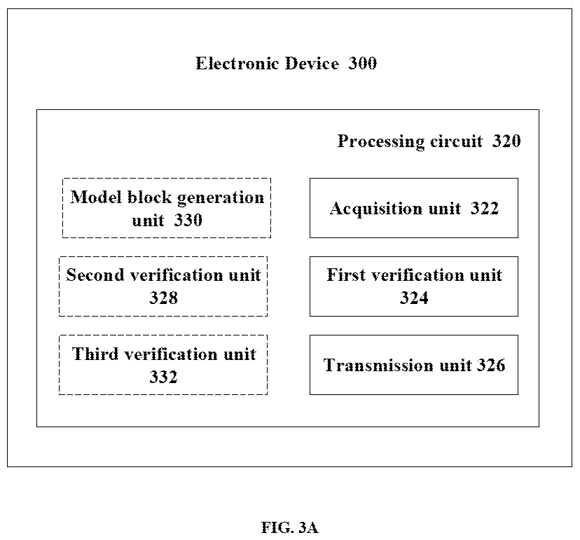

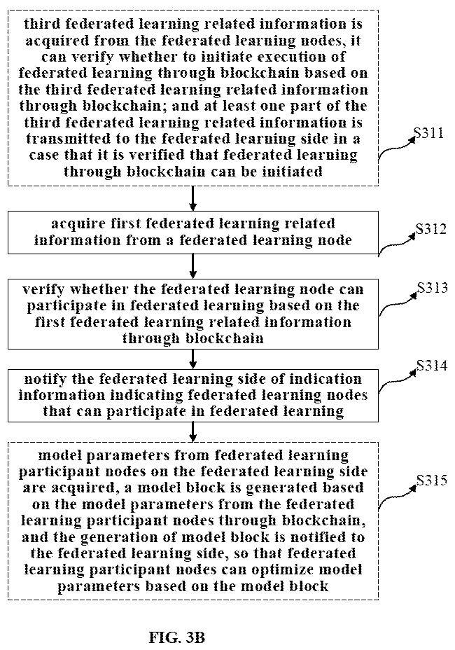

FIG. 3A shows a block diagram of an electronic device on a blockchain side according to an embodiment of the present disclosure. The blockchain side can interact with the federated learning side to perform blockchain-based federated learning. The electronic device 300 includes a processing circuit 320, and the processing circuit 320 may be configured to acquire first federated learning related information from a federated learning node, cause verifying whether the federated learning node can participate in federated learning based on the first federated learning related information through blockchain, and notify the federated learning side of indication information indicating federated learning nodes that are allowed to participate in federated learning. Therefore, the federated learning participant nodes can be determined on the federated learning side based on the indication information, so as to participate in the federated learning.

In an embodiment of the present disclosure, the first federated learning related information may be included in a federated learning participation request sent by a federated learning node, where the federated learning node may include a federated learning participation node. The federated learning related information can comprise various appropriate types of information and can be expressed in various appropriate forms, such as character strings, vectors and so on. In particular, the information related to federated learning can include node identity information, and business-related information, the former can include node identity identification, and the latter can be used to characterize whether the node can meet the requirements of federated learning, for example, it can include information related to execution of federated learning businesses, especially information related to data and/or model participating in federated learning. In particular, the business-related information may include at least one of the following first to third sub-information.

According to an embodiment of the present disclosure, the first federated learning related information may include the first sub-information, which may represent information related to data that can be used to or is expected to be used to perform federated learning, and may be called data metadata information. Data metadata information may include, but not limited to, at least one of data attribute information, data structure information and data distribution information. However, the data metadata information does not include the data itself, so the local data of the learning node that can be used for federated learning will not be transmitted to the blockchain. The data that can be used to or is expected to be used to perform federated learning here may include the available data of the federated learning node itself.

In some embodiments, the data attribute information may include at least one of data identifier, data size, data type, and data amount. In some embodiments, the data structure information includes at least one of data length, data field and data arrangement. In some embodiments, the data distribution information includes at least one of data discreteness, data integrity, data location, data relevance and data owner.

According to an embodiment of the present disclosure, the first federated learning related information may further include the second sub-information, which may represent information related to data (e.g., processing results) obtained by local processing when performing federated learning for a specific application, business, service, etc. Especially, in the application of model training, the obtained data is the result of model training. The second sub-information may include information related to model parameters, including, for example, at least one of model type, model weight and model gradient.

According to an embodiment of the present disclosure, the first federated learning related information may further include the third sub-information, which may represent information related to such as attributes of local processing, execution of local processing, participation status in federated learning, etc., and may be referred to as federated learning metadata information, and may be used to judge whether it is suitable for federated learning. As an example, it can represent information related to local processing participating in federated learning, for example, including at least one of participant identifier, the type of local processing, the amount of local data samples, the accuracy of local processing, the status of participating in federated learning and other information. Particularly, in model training, the third sub-information may represent information related to model training, which may include at least one of parameters related to model attributes, model training participation status, data used for model training, and the like. As an example, the third sub-information may be referred to as model metadata information, which may include information, such as participant identifier, the model type, the number of samples for training in the local data set, the training accuracy of the local model, the number of times of participating in the federated learning, and so on.

According to an embodiment of the present disclosure, the first federated learning related information may further comprise identity information, which may be expressed as an identity identifier of a federated learning node that transmits a federated learning participation request.

According to an embodiment of the present disclosure, the processing circuit may be further configured to cause verifying whether the first federated learning related information from a federated learning node meets the federated learning requirements through blockchain, and if the federated learning related information meets the federated learning requirements, confirm that the federated learning node can participate in federated learning, for example, it can serve as a federated learning participant node.

In some embodiments, at least one of the sub-information included in the first federated learning related information can be verified, and under the condition that at least one of the first federated learning related information meets the corresponding requirements, it can be judged that the federated learning node can participate in federated learning. For example, as long as any one of the above sub-information meets the requirements, it can be judged that the federated learning node can participate in federated learning.

Especially, for data metadata information, it can be verified whether the data metadata meets the requirements of federated learning, including but not limited to at least one of metadata standards, federated learning standards, and etc., and when the data metadata meets the requirements of federated learning, the federated learning node can participate in federated learning. For example, at least one of the following can be performed, particularly, it can verify whether the format of field list meets the format requirement, such as whether it meets the format required by federated learning, and when it complies with the required format, the federated learning node can participate in federated learning, whether the amount of samples meets the quantity requirement of federated learning, for example, whether the amount of samples reaches or exceeds the amount of samples required by federated learning, so that when the amount of samples is large enough, it can participate in federated learning, whether the missing ratio of data meets the federated learning requirement, for example, it is determined whether the missing ratio of data is lower than a specific threshold through blockchain, so that when there is not much data missing, the federated learning node can participate in federated learning, whether the dispersion degree of data meets the dispersion requirement of federated learning, for example, it is determined whether the dispersion degree is less than a specific threshold through blockchain, so that when the data is not so disperse, the federated learning node can participate in federated learning, and so on. It can be confirmed that the federated learning node can participate in federated learning if the data metadata meets the data requirements of federated learning. In this way, by verifying the metadata parameters, it can be judged that the authenticity of the data, whether the data is suitable for federated learning, and so on, thus improving the reliability of federated learning.

For the information related to model parameters, it can be verified whether the model parameters meet the model requirements of federated learning, and when the model parameters meet the model requirements of federated learning, the federated learning node can participate in federated learning. For example, it can be verified at least one of whether the model type indicates a model supported by federated learning, whether model parameters such as model weight and gradient, etc. are abnormal, for example, whether model weight or gradient obviously deviates from a reasonable range, which can be, for example, a preset reference value or a statistical value based on previous model parameters, e.g., mean value, etc. In this way, the abnormal situation can be monitored by verifying the model parameters. If the model parameters meet the model requirements of federated learning, such as not deviating from a reasonable range, not abnormal, it can be confirmed that the federated learning node is credible or reliable and can participate in federated learning. Various monitoring technologies and safety or reliability detection technologies known in the field, such as supervision, semi-supervision and other technologies, can be applied here. In this way, suspicious or even deliberately false or destructive parameters can be prevented from being involved in federated learning, thus improving the accuracy and reliability of federated learning.

For the model metadata information, it can be verified whether the model metadata meets the corresponding requirements of federated learning, and it can participate in federated learning when the model metadata meets the corresponding requirements of federated learning. For example, it can be verified whether at least one of the model type, the amount of training samples in the local data set, the training accuracy of the local model and the number of times to participate in federated learning meet the requirements, and it can be confirmed that the federated learning node can participate in federated learning if the model metadata meets the corresponding requirements of federated learning. For example, it can be verified whether the model types match, for example, when they match, the federated learning node can participate in federated learning, it can be verified whether the amount of training samples is greater than or equal to the required amount of training samples, for example, when the amount of samples is sufficient, the federated learning node can participate in federated learning, it can be verified whether the training accuracy of the local model is greater than or equal to the accuracy threshold, for example, when the accuracy is sufficient, the federated learning node can participate in federated learning, it can be verified whether the number of times that have participated in federated learning is greater than the threshold, for example, the federated learning node can participate in federated learning when the federated learning node have participated in the federated learning in a certain number of times. Of course, it is not necessary to judge the number of times to participating in federated learning, meanwhile, setting the threshold for the number of times can further ensure that the participants in the federated learning are that have participated in federated learning in a certain number of times, which are more reliable, thus further improving the accuracy and reliability.

Identity information can be verified based on the identifier (ID) of the federated learning node. For example, the identity ID of a node can be compared with a database of participants who are allowed to participate in federated learning, and in the database, information about each node who is qualified to participate in federated learning, such as identity information, can be recorded, so that it can be confirmed that an initiation node is suitable to participate in federated learning if the received identity information of the initiation node matches the identity information in the database. Here, the database can be stored in a memory or the like, and it can be pre-stored or dynamically updated during the federated learning process, for example, during iterative execution of federated learning, in each iteration, after confirming the participant nodes, the database can be updated with the identity information of the confirmed participant nodes for use in the next iteration.

In some embodiments of the present disclosure, it can be considered that the federated learning node can participate in federated learning, after any one of the above data metadata information, model parameter related information, model metadata information, and identity information is verified to meet the requirements. In some implementations, for example, identity verification is not necessary, which can be applied to, for example, scenarios where the identity information of federated learning nodes allowed to participate in federated learning is not known in advance or need not to be known or is not important. As an example, it may be the first iteration of federated learning or a situation that the requirements for data of federated learning are higher. In this way, identity verification is not required, as long as the data can meet the requirements of federated learning, and such node identities can be saved and then used for verification in subsequent processes, such as subsequent iterations. In other implementations, for example, only identity information may be verified. For example, when it is stipulated that, in some operations of federated learning iteration, the participants in each iteration remain unchanged, so that only the identity can be verified in each iteration.

In other embodiments of the present disclosure, identity verification is necessary, so that it is required that both identity information and business-related information meet the requirements to confirm that federated learning nodes can participate in federated learning. That is, only when the identity information is verified, and at least one of the above data metadata information, model parameter related information and model metadata information, for example, is verified, the node can be considered as being verified. In this way, it can ensure that the participants and participation data of federated learning are more reliable and accurate. For example, the identity information can be verified first, and other sub-information can be verified after the identity information is verified, and then after at least one of the sub-information meets the requirements, it can be confirmed that the federated learning node can participate in federated learning.

In an embodiment of the present disclosure, a federated learning node that issues a federated learning participation request may correspond to a federated learning intention/application node in an embodiment of the present disclosure, which may be determined in various appropriate ways. For example, as mentioned above, such node can be specified by the system in advance, or it can also be determined by the federated learning node itself whether to serve as an intention node. For example, the federated learning node can judge whether its own information matches or is similar to the specific federated learning-related information, and in the case of matching or being similar, it will serve as a requesting node. According to an embodiment of the present disclosure, the specific federated learning-related information may correspond to the aforementioned second federated learning-related information, for example, it may be at least one of information used to characterize federated learning for a specific application or business or service, such as its attributes or requirements, etc., and it may be in various appropriate forms, such as character strings, vectors, etc. In some embodiments, the second federated learning related information may comprise information at least partially the same format as the first federated learning related information, including, for example, at least one of the aforementioned data metadata information, model parameter information, model metadata information, and the like.

According to the embodiment of the present disclosure, the second federated learning related information can be acquired in an appropriate manner. In some embodiments, the second federated learning related information may be provided by the blockchain side. In some embodiments, it can be transmitted to the federated learning side by the blockchain side under the condition that it is determined that federated learning can be initiated/started on the blockchain side, for the node of the federated learning side to confirm. In some embodiments, the processing circuit may be further configured to cause verifying whether to initiate execution of federated learning through blockchain based on third federated learning related information in the federated learning initiation request through blockchain; and transmit at least a part of the third federated learning related information to a federated learning node under the condition that it is verified that federated learning through blockchain can be initiated. Here, at least a part of the third federated learning related information can be used as the second federated learning related information.

In some embodiments, the third federated learning-related information may comprise information which is at least partially the same format as the first federated learning-related information, including at least one of the aforementioned data metadata information, model parameter information, model metadata information, identity information, etc., and the judgment condition for verifying whether to initiate federated learning may also be carried out in a similar way to the way for judging whether to allow participation in federated learning, for example, it can be verified at least one of data metadata information, model parameter information, model metadata information, identity information, etc. in the third federated learning-related information meets its corresponding requirement. Of course, a simplified manner can also be adopted, for example, if the identity verification passes, federated learning can start directly without verifying other information.

According to an embodiment of the present disclosure, the indication information indicating the federated learning participants can be notified to the federated learning side in an appropriate manner, for example, broadcasted to the federated learning side. In some embodiments, the indication information may be notified to the federated learning side once the federated learning participant nodes are determined, therefore, participant nodes in federated learning can conduct federated learning, such as model training, on the federated learning side. In another embodiment, after the subsequent processing continues to perform after the federated learning participant nodes are verified, the indication information can be transmitted to the federated learning side together with the results of the subsequent processing. For example, the federated learning participant nodes may further transmit data, such as federated learning application data, to the blockchain side, so that the blockchain side generates blocks for the federated learning side to use.

According to embodiments of the present disclosure, the subsequent processing may include credibility verification of federated learning application data through blockchain, and computation processing based on federated learning application data, such as generating application-related blocks. In some embodiments, the federated learning application data may be generated locally by the participant nodes when the federated learning is conducted for a specific application, business, service, etc., and may be of any appropriate type, for example, it may be of the same type as at least a part of the aforementioned first to third federated learning related information, as mentioned above. As an example, in the federated learning scenario of model training, federated learning application data can correspond to information about model parameters.

In some embodiments, the processing circuit may be further configured to verify the credibility of model parameters from federated learning participant nodes, and based on the model parameters from federated learning participant nodes that are verified to be credible, generate model blocks. The model parameters belong to an example of federated learning application data in a scenario where federated learning is used for model training, and when they serve as the first federated learning related information, the above-mentioned participant verification and credibility verification can be performed concurrently. Credibility verification can be implemented in various appropriate ways, for example, in the same way as the verification manner when the first federated learning related information includes model parameters, for example, by the smart contract method or any other blockchain technology.

In addition, the indication information of the participants can be transmitted to the federated learning side after the credibility verification, or even transmitted to the federated learning side together with relevant information generated by the model block.

In some embodiments, the processing circuit may be further configured to notify the federated learning participant nodes of the generation of model blocks, so that the federated learning participant nodes can acquire the model blocks for local model parameter optimization. For example, the generation of a model block will be broadcasted to the federated learning side, so that the federated learning side can acquire the model block from the blockchain side after receipt of the broadcast, for model optimization of federated learning participant nodes, such as updating of model parameters of federated learning participant nodes.

According to embodiments of the present disclosure, the model blocks may be in various appropriate forms, such as sub-model blocks or a global model block obtained based on sub-model blocks. In particular, in some implementations, sub-model blocks are usually generated for model parameters of a specific number of federated learning participant nodes, for example, for model parameters of one federated learning participant node (this can be the scenario where federated learning nodes and blockchain nodes correspond to each other one by one), or for model parameters of two or more federated learning participant nodes (this can be a scenario where one blockchain node corresponds to multiple federated learning nodes and relevant parameter data are integrated in advance), and a global model block can be generated by combining the sub-model blocks.

In some embodiments, the processing circuit may be further configured such that at least one of a sub-model block and a global model block can be generated through blockchain technology based on model parameters from federated learning participant nodes, so that federated learning participant nodes can optimize local model parameters based on at least one of the generated sub-model block and the global model block.

In some embodiments, the processing circuit may be further configured such that sub-model blocks are generated through blockchain technology based on federated learning model parameters from federated learning participant nodes, and the generation of sub-model blocks is notified to the federated learning side. In other embodiments, the processing circuit may be further configured such that sub-model blocks are generated through blockchain technology based on federated learning model parameters from federated learning participant nodes, the generated sub-model blocks are aggregated through blockchain technology to generate a global model block, and the generation of the global model block is notified to the federated learning side.

In some embodiments, the blockchain side can adopt various appropriate ways to generate sub-model blocks. For example, a consensus mechanism can be employed, for the model parameters of each federated learning participant node, to generate corresponding sub-model blocks through blockchain. In some embodiments, the blockchain side can adopt various appropriate ways to generate a global model block. In one implementation, a specific blockchain node can be selected from the blockchain side nodes to acquire all sub-model blocks generated in the blockchain network and integrate them. The specific blockchain node may be selected in an appropriate manner, such as alternative selection or voting selection of blockchain nodes, or may also be selected based on the characteristics of blockchain nodes. As an example, a node with the highest processing capacity, an idlest node or a node with the highest processing efficiency among the blockchain nodes can be employed, of course, any other node can be employed, as long as the operation can be successfully performed to generate the global model block. The control node or the coordination node can be preset, or it can be dynamically selected during the global model is generated. It should be pointed out that the control node or coordination node in the blockchain may be the same as or different from the aforementioned verification node.

It should be pointed out that the above operation of generating sub-model blocks or global model block on the blockchain side can be applied to appropriate model training scenarios, especially in the case of federated learning based on data metadata information, model parameter information, model metadata information, etc., in which, for example, at least one of participant verification and initiation verification can be performed by using such information.

According to embodiments of the present disclosure, the blockchain-based federated learning can be iteratively performed until the requirements of applications, businesses or services are met. For example, in an application scenario of model training, if the model obtained by federated learning still does not meet specific requirements, for example, does not converge, does not reach predetermined times of iteration, does not meet model performance requirement, etc., the next federated learning continues, until an iteration stop condition is met, for example, the condition can correspond to any of model performance requirement, convergence condition, iteration times, etc.

Usually, iteration is demand oriented. Whether the iteration stops or not can be initiated by the federated learning initiator. For example, an application scenario of this application is that a node requests to initiate the blockchain-based federated learning, and after performing federated learning, it will judge whether the result meets the requirement or reaches the termination condition, and if not, the iteration will continue.

In this disclosure, iteration can be performed in various appropriate ways. In some embodiments, identity authentication may not be required in the iteration process, for example, in the case of performing iteration, the blockchain will only acquire the information about participants determined previously; or, after constructing a combination of federated learning participant nodes, the initiator will directly request other participant nodes to participate in the iteration, for example, notify other participant nodes to perform the iteration, and when the iteration termination condition is met, notify other nodes to not perform the iteration. In this way, the blockchain side will only filter the data without verifying the participants. In still other embodiments, participants can be re-verified in the iteration, for example, after the node initiates the request, the participation request can be directly sent by the previously determined intention node, so that it can be directly verified whether the intention node can serve as the participant node to perform federated learning. In this way, the participants will be updated dynamically in each iteration, and the effect will be better. In still other embodiments, the iteration can even start from federated learning initiation.

In embodiments of the present disclosure, the electronic device, especially processing circuit, can be realized in various ways, and have various appropriate structures. As an example, in a structural example of an electronic device, the processing circuit 320 may be in the form of a general-purpose processor or a special-purpose processor, such as an ASIC. For example, the processing circuit 320 can be configured by a circuit (hardware) or a central processing device such as a central processing unit (CPU). Further, the processing circuit 320 may carry a program (software) for operating a circuit (hardware) or a central processing device. The program can be stored in a memory, for example, arranged in the memory, or an external storage medium connected from the outside, and downloaded via a network, such as the Internet.

According to an embodiment of the present disclosure, the processing circuit 320 may include various units for implementing the above functions, such as an acquisition unit 322 configured to acquire first federated learning related information from a federated learning node, a first verification unit 324 configured to verify whether the federated learning node can participate in federated learning based on the first federated learning related information through blockchain, and a transmission unit 326 configured to notify the federated learning side of indication information indicating federated learning nodes that can participate in federated learning, so that the indicated federated learning nodes that can participate in federated learning can perform model optimization based on federated learning.

In some embodiments, the first verification unit 324 may be further configured to verify whether the first federated learning related information meets a federated learning requirement through blockchain; and confirm that the federated learning node can participate in federated learning under the condition that the first federated learning related information meets the federated learning requirement.

In some embodiments, the first verification unit 324 may be further configured to verify whether at least one piece of information contained in the first federated learning related information meets a corresponding federated learning requirement through blockchain; and confirm that the federated learning node can participate in federated learning under the condition that the at least one piece of information contained in the first federated learning related information meets the corresponding federated learning requirement.

In some embodiments, the processing circuit 320 may further include a unit configured to acquire model parameters from federated learning participant nodes on the federated learning side, a model block generation unit 330 configured to generate a model block based on the model parameters from the federated learning participant nodes through blockchain, and a unit configured to notify the federated learning side of the generation of model block, so that federated learning participant nodes can optimize model parameters based on the model block.

In some embodiments, the processing circuit 320 further includes a second verification unit 328 configured to verify credibility of model parameters from federated learning participant nodes, and the unit 330 is configured to generate the model block based on the model parameters verified as credible.

In some embodiments, the unit 330 may be further configured to generate sub-model blocks based on model parameters from federated learning participant nodes through blockchain, and aggregate the generated sub-model blocks through blockchain technology to generate a global model block.

In some embodiments, the processing circuit 320 further includes a unit configured to acquire third federated learning related information from the federated learning nodes, a third verification unit 332 configured to verify whether to initiate execution of federated learning through blockchain based on the third federated learning related information through blockchain; and a unit configured to transmit at least one part of the third federated learning related information to the federated learning side in a case that it is verified that federated learning can be initiated through blockchain.

The operation of each unit can be carried out as described above and will not be described in detail here. In the drawings, some units are drawn with dashed lines to illustrate that the units are not necessarily included in the processing circuit. As an example, the units may be included in a blockchain-side electronic device and outside the processing circuit, or even outside the blockchain-side electronic device 300. It should be noted that although each unit is shown as a separate unit in FIG. 3A, one or more of these units may be combined into one unit or split into multiple units. For example, various acquisition functions can be realized by a single acquisition unit, while various transmission/notification functions can be realized by a single transmission unit.

It should be noted that the above-mentioned units are only logical modules divided according to their specific functions, instead of being used to limit their specific implementation, for example, they can be implemented in software, hardware or a combination of software and hardware. In actual implementation, the above units can be realized as separate physical entities, or can also be realized by a single entity, for example, a processor such as CPU or DSP, etc., an integrated circuit, etc. In addition, the above-mentioned units are shown in the drawings by dotted lines, indicating that these units may not actually exist, and the operations/functions they realize may be realized by the processing circuit itself.

It should be understood that FIG. 3A is only a schematic structural configuration of the blockchain-side electronic device, and the blockchain-side electronic device 300 may also include other possible components, e.g., memory, etc. Optionally, the blockchain-side electronic device 300 may also include other components not shown, such as a memory, a radio frequency link, a baseband processing unit, a network interface, a controller, and the like. The processing circuit may be associated with a memory and/or an antenna. For example, the processing circuit can be directly or indirectly connected to the memory, for example, other components may be connected therebetween, to access data. As another example, the processing circuit may be directly or indirectly connected to the antenna to transmit signals via the communication unit and receive radio signals via the communication unit.

The memory may store various information generated by the processing circuit 320, for example, various data generated in the federated learning, etc., programs and data used for the operation of the blockchain side electronic device, data to be transmitted by the blockchain side electronic devices, and the like. The memory may also be located inside the blockchain-side electronic device but outside the processing circuit, or even outside the blockchain-side electronic device. The memory may be a volatile memory and/or a nonvolatile memory. For example, the memory may include, but not limited to, random access memory (RAM), dynamic random access memory (DRAM), static random access memory (SRAM), read-only memory (ROM), and flash memory.

FIG. 3B illustrates a flowchart of a blockchain side method according to an exemplary embodiment of the present disclosure. In method 310, in step S312, acquire first federated learning related information from a federated learning node, in step S313, verify whether the federated learning node can participate in federated learning based on the first federated learning related information through blockchain, and in step S314, notify the federated learning side of indication information indicating federated learning nodes that can participate in federated learning, so that the indicated federated learning nodes that can participate in federated learning can perform model optimization based on federated learning.

In some embodiments, step S312 further includes verifying whether the first federated learning related information meets a federated learning requirement through blockchain; and confirm that the federated learning node can participate in federated learning under the condition that the first federated learning related information meets the federated learning requirement.

In some embodiments, the step S312 further includes verifying whether at least one piece of information contained in the first federated learning related information meets the corresponding federated learning requirement through blockchain; and confirm that the federated learning node can participate in federated learning under the condition that the at least one piece of information contained in the first federated learning related information meets the corresponding federated learning requirement.

In some embodiments, the method 310 further includes step S315, wherein model parameters from federated learning participant nodes on the federated learning side are acquired, a model block is generated based on the model parameters from the federated learning participant nodes through blockchain, and the generation of model block is notified to the federated learning side, so that federated learning participant nodes can optimize model parameters based on the model block.

In some embodiments, step S315 may further include verifying the credibility of model parameters from federated learning participant nodes, and the model block can be generated based on the model parameters verified as credible.

In some embodiments, step S315 may further include generate sub-model blocks based on model parameters from federated learning participant nodes through blockchain, and aggregate the generated sub-model blocks through blockchain technology to generate a global model block.

In some embodiments, the method may further include step S311, where third federated learning related information is acquired from the federated learning nodes, it can verify whether to initiate execution of federated learning through blockchain based on the third federated learning related information through blockchain; and transmit at least one part of the third federated learning related information to the federated learning side in a case that it is verified that federated learning can be initiated through blockchain.

It should be pointed out that the method according to the present disclosure may further include operation steps corresponding to those performed by the processing circuit of the electronic device on the blockchain side, which will not be described in detail here. It should be noted that each operation of the method according to the present disclosure can be performed by the above-mentioned blockchain-side electronic device, especially by the processing circuit or corresponding processing units of the blockchain-side electronic device, and will not be described in detail here. Some steps are drawn in the drawings with dashed lines, in order to illustrate that such steps are not necessarily included in the above method.

The implementation of federated learning side for the blockchain-based federated learning according to an embodiment of the present disclosure will be described below with reference to the accompanying drawings. Similar to the implementation on the blockchain side, the operations performed by the federated learning side according to the embodiment of the present disclosure can be realized by an electronic device on the federated learning side. The electronic device can be outside the federated learning network and can control or cause the federated learning node to operate; or it may be within a federated learning network, for example, as a federated learning node or a part thereof, such as its members, components, etc., like as described above for the blockchain-side verification node. In one implementation, the electronic device may correspond to the aforementioned federated learning node on the blockchain side, such as at least one of federated learning initiation node, federated learning application node and federated learning participation node, or may implement the function/operation of at least one of federated learning initiation node, federated learning application node, and federated learning participation node.

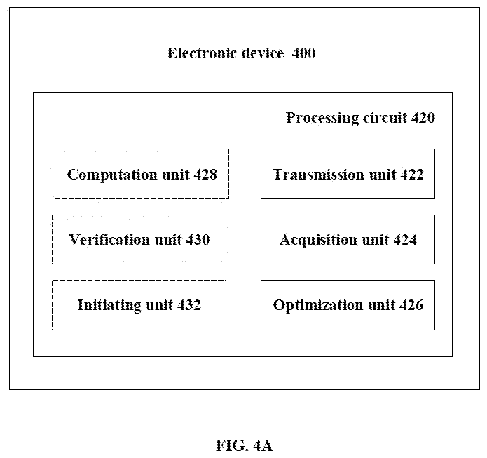

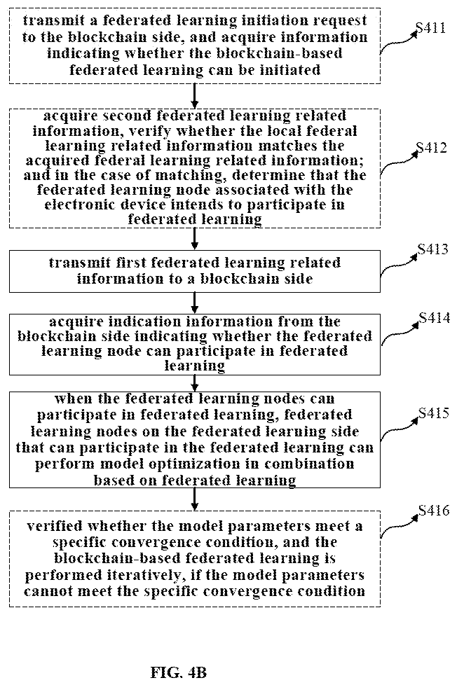

FIG. 4A shows a block diagram of an electronic device on a federated learning side of blockchain-based federated learning according to an exemplary embodiment of the present disclosure. The electronic device 400 may include a processing circuit 420, which may be configured to transmit first federated learning related information to the blockchain side in the case that a federated learning node associated with the electronic device intends to participate in federated learning, acquire indication information from a blockchain side indicating whether the federated learning node can participate in federated learning, wherein the indication information is generated by verifying the federated learning related information through a blockchain; and under the condition that it is determined that the federated learning node associated with the electronic device can participate in federated learning based on the indication information, each federated learning node on the federated learning side that can participate in the federated learning can perform model optimization based on federated learning. For example, global data can be obtained based on federated learning application data of federated learning nodes on the federated learning side, and the federated learning node associated with the electronic device can be optimized by using the global data.

The federated learning application data can have the meaning as described hereinbefore, for example, in the case of model training through federated learning, it can correspond to model parameters obtained by federated learning nodes through local model training, and the global data means global model parameters obtained based on the model parameters of federated learning nodes on the federated learning side, therefore, each federated learning participant node can optimize its local model based on the global model parameters, such as parameter optimization and updating of the local model.

In one implementation, the processing circuit may be further configured to transmit federated learning application data from the federated learning node to the blockchain side, and acquire a global model block for local model optimization based on the global model block, wherein the global model block is generated based on model parameters in federated learning application data through blockchain.

According to some embodiments, the global model parameters can be generated on the blockchain side, and in particular, they can be acquired by processing the federated learning application data of federated learning participant nodes on the blockchain side, corresponding to the aforementioned global model block, as mentioned above. In some implementations, the processing circuit may be configured to acquire a notification of global model block generation, and acquire the global model block from the blockchain side based on the notification, for example, downloaded from a blockchain, especially a specific device on the blockchain side.

Accord to some embodiments, the global model parameters may be generated at the federated learning side.

In some embodiments, the global model parameters can be generated directly on the federated learning side. In particular, after the federated learning participant nodes are determined, the federated learning application data, such as model parameters, of the federated learning participant nodes can be aggregated at the federated learning side to generate global model parameters, and then each federated learning node can perform local model optimization based on the global model parameters. In some embodiments, the global model parameters can be generated by a specific federated learning node or its associated device by acquiring the model parameters of the participant nodes, such as aggregation generation, and be notified to each federated learning participant node, such as by broadcasting the generation of global parameters for other participants to download, or directly transmitting the model parameters. Here, the specific federated learning node can be a trusted specific federated learning participant node and can be referred to as a coordinator. The coordinator can be set in various appropriate ways. As an example, the control node or the coordination node can be appropriately selected from the set of federated learning nodes, for example, according to processing capacity, processing efficiency, idle state, etc. of the control node, can be statically selected, for example, pre-selected, for example, before parameter optimization, even before the start of federated learning, or can be dynamically selected, for example, during each iteration process. It should be pointed out that the control node or the coordination node may be the same as or different from the aforementioned federated learning initiation node.

In other embodiments, global model parameters can be generated by each federated learning participant node, for example, acquiring model parameters of other participant nodes and aggregating them locally into the global model parameters, and be used for local model optimization.

In some embodiments, the processing circuit may be further configured to acquire federated learning application data of federated learning nodes, aggregate model parameters in the federated learning application data of federated learning nodes to generate global model parameters, and perform local model optimization using the global model parameters. In some embodiments, the generated global model parameters can also be transmitted to federated learning participant nodes. This implementation can correspond to that the federated learning node associated with the processing unit serves as the coordinator at the federated learning side.

It should be pointed out that the above operation of directly generating global model parameters on the federated learning side can be applied to appropriate model training scenarios, especially the case of federated learning based on model metadata information, in which, for example, at least one of participant verification and initiation verification can be performed by using model metadata.

In some embodiments, the global model parameters may also be generated through blockchain. In particular, the federated learning application data, e.g., model parameters, of each federated learning participant node can be transmitted to the blockchain side to generate sub-model blocks through blockchain, and then each federated learning node can acquire the sub-model blocks and generate global model parameters based on the sub-model blocks for local model optimization. The way in which each federated learning node acquires the sub-model blocks and generates global model blocks based on sub-model blocks can be similar to the way in which each federated learning node generates global model parameters based on model parameters, for example, through a coordinator or generated by each learning node itself, which will not be described in detail here.

In some embodiments, the processing circuit may be further configured to transmit federated learning application data from the federated learning node to the blockchain side, acquire sub model blocks, wherein the sub model blocks are generated based on federated learning model parameters of federated learning participant nodes through blockchain; generate a global model block based on the acquired sub-model blocks; and perform local model optimization based on the global model block. In some embodiments, the generated global model data can also be transmitted to federated learning participant nodes. This implementation can correspond to that the federated learning node associated with the processing unit serves as the coordinator of the federated learning side.

It should be pointed out that the above operation of directly generating the global model block on the federated learning side can be applied to appropriate model training scenarios, especially the case of federated learning based on at least of data metadata information, model parameter information, model metadata information, etc., in which, for example, at least one of participant verification and initiation verification can be performed by using such information.

As an example, the generation of global model parameters or global model blocks can be notified on the federated learning side by broadcasting. As another example, information can also be directly transmitted to federated learning participant nodes, for example, all federated learning participant nodes can be known in the aforementioned indication information, for transmission.

In some embodiments, the processing circuit may be further configured to transmit a federated learning initiation request to the blockchain side, wherein the federated learning initiation request includes third federated learning related information, and acquire information indicating that the blockchain-based federated learning can be initiated. The federated learning node may correspond to the federated learning initiation node in the embodiment of the present disclosure.

In some embodiments, the processing circuit may be further configured to acquire specific federated learning related information from the federated learning initiation request; verify whether the local federated learning related information is similar with or matches the acquired specific federated learning related information; and in the case of being similar or matching, it is determined that the federated learning node associated with the electronic device intends to participate in federated learning. The specific federated learning-related information here can be transmitted by the blockchain side, which can correspond to the second federated learning-related information, for example, it can be at least a part of the third federated learning-related information, as mentioned above, or other appropriate information that can be used to verify whether it is suitable to participate in the federated learning.

According to the embodiment of the present disclosure, verifying whether the local federated learning related information is similar with or matches the acquired specific federated learning related information can be carried out in various appropriate ways. In some embodiments, it is possible to verify feature similarity between the local federated learning-related information and the second federated learning-related information, for example, whether the businesses/applications involved in each federated learning-related information are similar, for example, whether the information that they contain all belongs to features related to the same business/application. For example, in the case of audio, video and other applications, whether both kinds of information are indicated for audio, video and other applications. In other embodiments, sample similarity between the local federated learning-related information and the second federated learning-related information can be verified, for example, whether the sample data-related information contained in each federated learning-related information indicates whether the types and sources of data used by these nodes for federated learning are similar, for example, whether such nodes have all used the same or similar types of data, data from the same or similar sources, etc. And they can be considered as matching under the condition that the data is similar.

In some embodiments, the processing circuit may be further configured to verify whether a local model parameter meets a specific condition, and perform blockchain-based federated learning iteratively if the local model parameter cannot meet the specific condition. As an example, the specific condition correspond to a specific termination condition, such as at least one of convergence condition, iteration times, model performance requirement, etc., and if convergence is not reached, the predetermined iteration times is not reached, the model performance requirement is not met, etc., the next federated learning continues until iteration stop conditions, which, for example, can correspond to model performance requirements, convergence conditions, iteration times, etc., are met. The judgment of iteration termination can also be realized in other ways known in the art, which will not be described in detail here.

In the embodiment of the present disclosure, the iteration may be triggered by a specific device or node on a specific federated learning side, and for example, the iteration may be performed from the aforementioned different federated learning stages. In some embodiments, only operations of federated learning participant nodes can be iteratively performed, for example, the federated learning node iteratively acquires global model parameters or global model blocks, and then updates the local model, as mentioned above. In this way, it is unnecessary to perform the aforementioned operations of federated learning initiation and federated learning participant verification. In some embodiments, iteration can be performed from the federated learning participant verification operation, for example, the federated learning participant verification can be performed iteratively, and then the federated learning participant acquires the global model parameters or global model blocks and updates the local model, as mentioned above. In this way, it is unnecessary to perform the aforementioned federated learning initiation. Also in some embodiments, federated learning can be iteratively performed from the verification operation of federated learning intention participants, or even from the initiation of federated learning.

It should be pointed out that the meanings of various requests, information, etc. in the process/operation realized by the above processing circuit 420 are the same as those described above, and will not be described in detail here. In addition, the electronic device 400 and the processing circuit 420 can be implemented in a similar way to the aforementioned electronic device 300 and the processing circuit 320, such as a processor, a unit, a program module and the like.

In some embodiments, the processing circuit 420 may include a transmission unit 422 configured to transmit first federated learning related information to the blockchain side, an acquisition unit 424 configured to acquire indication information from the blockchain side indicating whether the federated learning node can participate in federated learning, wherein the indication information is generated by verifying the federated learning related information through a blockchain; and an optimization unit 426 configured to, under the condition that it is determined that the federated learning node associated with the electronic device can participate in federated learning based on the indication information, federated learning nodes on the federated learning side that can participate in the federated learning can perform model optimization in combination based on federated learning.

In some embodiments, the processing circuit 420 may further include a unit for acquiring global model parameters, which are generated based on model parameters of federated learning nodes on the federated learning side that can participate in federated learning; and the optimization unit 426 is configured to perform model optimization based on the global model parameters.

In some embodiments, the processing circuit 420 may further include a unit configured to acquire model parameters of federated learning nodes on the federated learning side that can participate in federated learning; a computation unit 428 configured to generate global model parameters by aggregating the model parameters of federated learning nodes; and a unit configured to transmit the global model parameters to each federated learning node.

In some embodiments, the processing circuit 420 may further include a unit configured to transmit model parameters acquired by the federated learning node through local model training to the blockchain side, and a unit configured to acquire a global model block, which is generated based on model parameters of federated learning nodes on the federated learning side that can participate in the federated learning through blockchain; and the optimization unit 426 is configured to perform local model optimization based on the global model block.

In some embodiments, the processing circuit 420 may further include a unit configured to acquire sub-model blocks generated based on model parameters of federated learning nodes through blockchain; and the computation unit is configured to aggregate the acquired sub-model blocks into the global model block.

In some embodiments, the processing circuit 420 may further include a unit configured to distribute the global model block to other federated learning nodes capable of participating in federated learning.

In some embodiments, the processing circuit 420 may further include a unit configured to acquire second federated learning related information, a verification unit 430 configured to verify whether the local federated learning related information matches the acquired federated learning related information; and in the case of matching, it is determined that the federated learning node associated with the electronic device intends to participate in federated learning.

In some embodiments, the processing circuit 420 may further include an initiating unit 432 configured to transmit a federated learning initiation request to the blockchain side, wherein the federated learning initiation request includes third federated learning related information; and a unit configured to acquire information indicating whether the blockchain-based federated learning can be initiated, wherein the information is generated by verifying the third federated learning related information through blockchain.

In some embodiments, the processing circuit 420 may further include an iteration triggering unit 434 configured to verify whether the model parameters meet a specific convergence condition, and trigger iterative blockchain-based federated learning if the model parameters cannot meet the specific convergence condition.

In addition, similar to the processing circuit 320, the processing circuit 420 may also include the aforementioned additional components, which will not be described in detail here.

FIG. 4B illustrates a flowchart of a method on the federated learning side according to an exemplary embodiment of the present disclosure. In method 410, in step S413, transmitting first federated learning related information to a blockchain side, in step S414, acquiring indication information from the blockchain side indicating whether the federated learning node can participate in federated learning, wherein the indication information is generated by verifying the federated learning related information through a blockchain; and in step S415, under the condition that it is determined that the federated learning node associated with the electronic device can participate in federated learning based on the indication information, federated learning nodes on the federated learning side that can participate in the federated learning perform model optimization in combination based on federated learning.

In some embodiments, step S415 may further include acquiring global model parameters, which are generated based on model parameters of federated learning nodes on the federated learning side that can participate in federated learning; and model optimization is performed based on the global model parameters.

In some embodiments, step S415 may further include acquiring model parameters of federated learning nodes on the federated learning side that can participate in federated learning; generating global model parameters by aggregating the model parameters of federated learning nodes; and transmitting the global model parameters to each federated learning node.

In some embodiments, step S415 may further include transmitting model parameters acquired by the federated learning node through local model training to the blockchain side, and acquiring a global model block, which is generated based on model parameters of federated learning nodes on the federated learning side that can participate in the federated learning through blockchain; and local model optimization is performed based on the global model block.

In some embodiments, step S415 may further include acquiring sub-model blocks generated based on model parameters of federated learning nodes through blockchain; and aggregating the acquired sub-model blocks into the global model block.

In some embodiments, step S415 may also include distributing the global model block to other federated learning nodes capable of participating in federated learning.

In some embodiments, the method 410 may further include step S412, in which second federated learning related information is acquired, it is verified whether the local federated learning related information matches the acquired federated learning related information; and in the case of matching, it is determined that the federated learning node associated with the electronic device intends to participate in federated learning.

In some embodiments, the method 410 may further include step S411, in which a federated learning initiation request is transmitted to the blockchain side, wherein the federated learning initiation request includes third federated learning related information; and information indicating whether the blockchain-based federated learning can be initiated is acquired, wherein the information is generated by verifying the third federated learning related information through blockchain.

In some embodiments, the method 410 can also step S416, in which it is verified whether the model parameters meet a specific convergence condition, and the blockchain-based federated learning is performed iteratively, if the model parameters cannot meet the specific convergence condition.

It should be noted that the method according to the present disclosure may further include operation steps corresponding to operations performed by the processing circuit of the above-mentioned federated learning side electronic device, which will not be described in detail here. It should be noted that each operation of the method according to the present disclosure can be performed by the above-mentioned federated learning side electronic device, especially by the processing circuit or corresponding processing unit of the federated learning side electronic device, and will not be described in detail here.

Next, an overall implementation of blockchain-based federated learning according to an embodiment of the present disclosure will be described with reference to the drawings. In particular, the operation flow and signaling diagram of a whole system architecture of federated learning based on blockchain will be described.

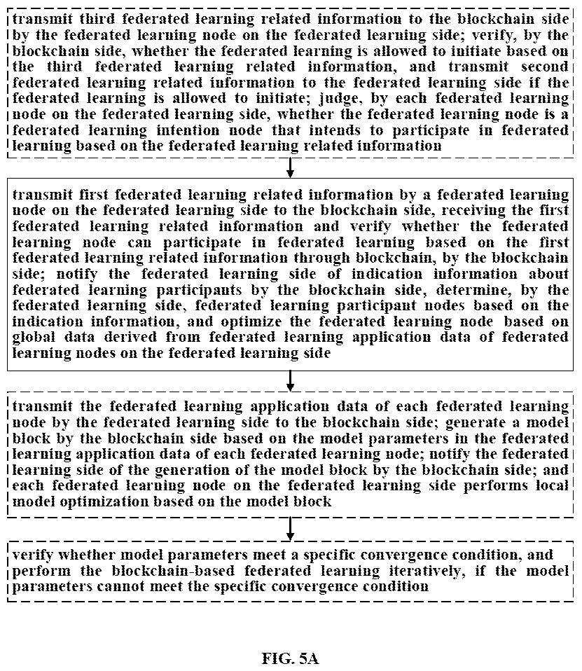

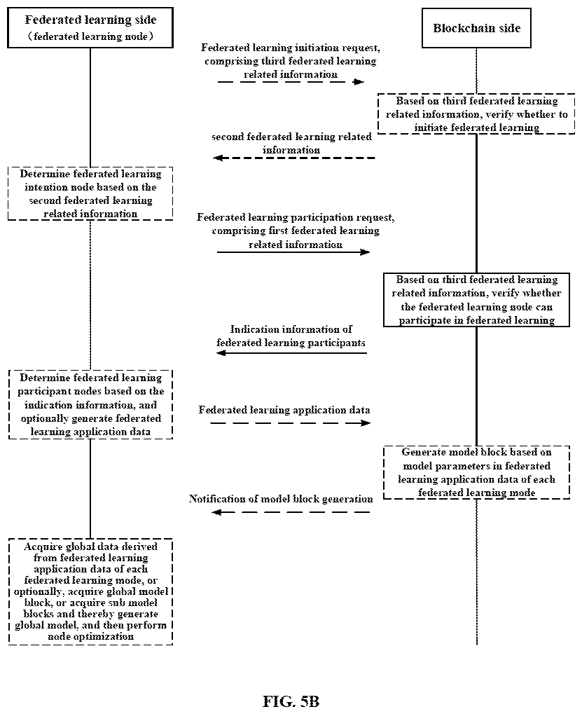

FIG. 5A shows an overall flowchart of the blockchain-based federated learning according to an embodiment of the present disclosure. FIG. 5B shows an overall signaling diagram of the blockchain-based federated learning according to an embodiment of the present disclosure.

According to an embodiment of the present disclosure, the blockchain-based federated learning method can be executed by a blockchain-based federated learning system, which includes a federated learning side and a blockchain side. The method may include the following steps: transmitting first federated learning related information by a federated learning node on the federated learning side to the blockchain side, receiving the first federated learning related information and verifying whether the federated learning node can participate in federated learning based on the first federated learning related information through a blockchain, by the blockchain side; notifying the federated learning side of indication information about federated learning participants by the blockchain side, determining, by the federated learning side, federated learning participant nodes based on the indication information, and wherein the federated learning node is optimized based on global data derived from federated learning application data of federated learning nodes on the federated learning side.

In an embodiment of the present disclosure, the method may further include the following steps: transmitting third federated learning related information to the blockchain side by the federated learning node on the federated learning side; verifying, by the blockchain side, whether the federated learning is allowed to initiate based on the third federated learning related information, and transmitting second federated learning related information to the federated learning side if the federated learning is allowed to initiate; judging, by each federated learning node on the federated learning side, whether the federated learning node is a federated learning intention node that intends to participate in federated learning based on the federated learning related information.

In an embodiment of the present disclosure, the method may further include the following steps: transmitting the federated learning application data of each federated learning node by the federated learning side to the blockchain side; generating a model block by the blockchain side based on the model parameters in the federated learning application data of each federated learning node; notifying the federated learning side of the generation of the model block by the blockchain side; and each federated learning node on the federated learning side performs local model optimization based on the model block. Generation of the model block and optimization based on the model block can be performed as described above, and will not be described in detail here.

In an embodiment of the present disclosure, the method may further include the following steps: each federated learning node on the federated learning side generates its own federated learning application data; generating global model parameters on the federated learning side based on model parameters in the federated learning application data of federated learning nodes; and each federated learning node performs local model optimization based on the global model parameters. The generation of global model parameters and the optimization based on the global model parameters can be performed as described above, and will not be described in detail here.

In an embodiment of the present disclosure, at least some of the above processes or signaling interactions may be iteratively performed, until certain conditions are met. As mentioned above, it will not be described in detail here.

An exemplary implementation of blockchain-based federated learning according to an embodiment of the present disclosure will be described below.

According to some embodiments of the present disclosure, in a first type of federated learning architecture in which federated learning participants are not blockchain nodes, on-chain can be implemented based on at least one of metadata-based on-chain, model-based on-chain and model metadata-based on-chain respectively, thus realizing multi-party secure computation among the participants and further enhancing the trust mechanism among the participants. Among them, the federated learning network is connected to the blockchain network in an appropriate communication mode, and each of the above-mentioned metadata, model and model metadata can correspond to each of the above-mentioned first to third federated learning related information, that is, as an example thereof. The above three on-chain operations will be described in detail below with reference to the first to third embodiments.

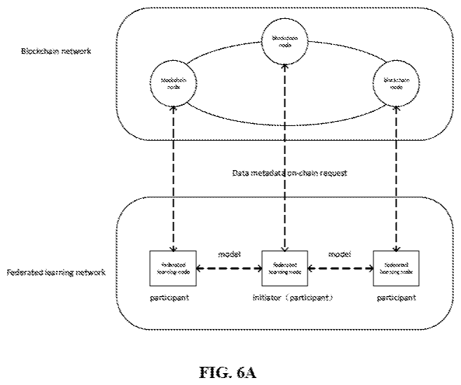

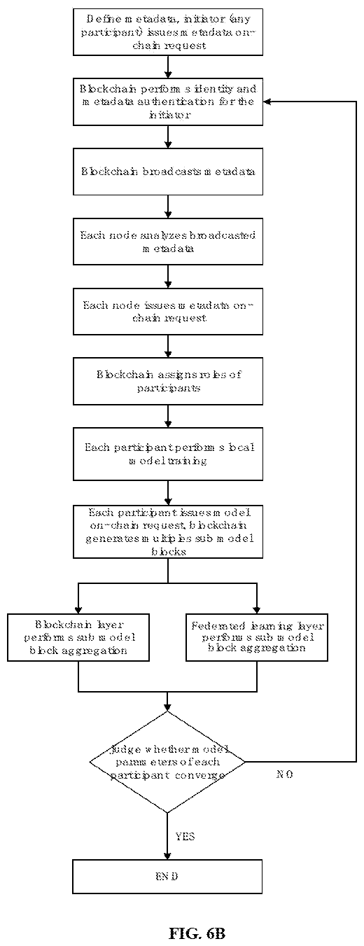

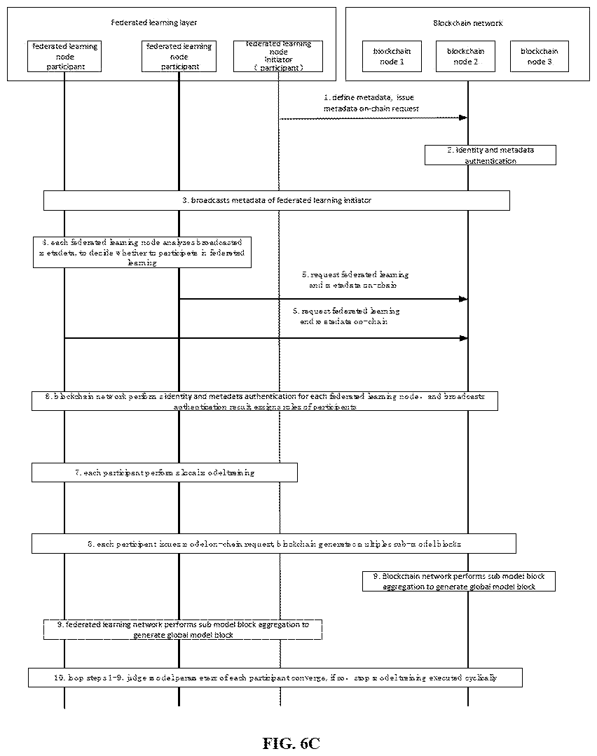

An exemplary implementation of blockchain-based federated learning according to a first embodiment of the present disclosure will be described below with reference to FIGS. 6A-6C. Among them, the participants in the federated learning are not blockchain nodes, and each participant node will conduct federated learning based on blockchain through the interconnection between the federated learning network and the blockchain network, access the blockchain based on metadata, and perform operations in the federated learning process.

The workflow of the architecture is as follows: the federated learning node issues an on-chain request (metadata of data), then the blockchain network performs verification (identity authentication and information authentication), then the blockchain network determines the role of the participant, and then the blockchain network or the federated learning network calculates a global model. The detailed description is as follows:

First, the federated learning node issues a metadata-of-data on-chain request (step 1). In particular, the federated learning initiator (any participant) transmits a metadata on-chain request to the blockchain, wherein the federated learning initiator provides at least one of identity information and metadata information of the federated learning initiator to the blockchain, and the actual data is still stored in the federated learning initiator.

Then, the blockchain network performs verification (for example, identity authentication and information authentication) based on the received information (step 2-3). In particular, the blockchain firstly authenticates the identity of the federated learning initiator (any participant), and after the identity authentication is successful, verifies the metadata, for example, checks the field list, sample amount, missing ratio, and/or whether the data is discrete, after the verification is successful, the blockchain network accepts the request of the initiator, and then broadcasts the metadata among the blockchain network. The blockchain broadcasts the metadata of the federated learning initiator to the whole network. On the other hand, if the verification is unsuccessful, the request is directly rejected.

Further, the blockchain network determines the roles of the participants (step 4-6). In particular, each federated learning node monitors the broadcast from the blockchain, downloads metadata, and performs analysis based on its local data and the broadcasted metadata, for example, feature similarity or sample ID alignment, to decide whether to participate in federated learning. Then, each federated learning node that decides to participate in the federated learning uploads its own metadata to the blockchain and requests to participate in federated learning. The blockchain side performs identity verification and metadata verification for the nodes that intend to join the federated learning, for example, whether the metadata criteria and the federated learning criteria are satisfied, to decide whether to agree with the federated learning request, and broadcast the verification results throughout the network, and assign the roles of participants. Specifically, if the identity verification passes and the metadata satisfies the metadata criteria and the federated learning criteria, it can be considered that the intention party issuing the request can serve as a participant in the federated learning.

Next, the global model is calculated by the blockchain network or the federated learning network (step 7-10).

A federated learning initiator (any participant) and participant start the federated learning, and conduct model training based on local data respectively. Then a model on-chain request is issued, and the blockchain forms a plurality of sub-model blocks. Each participant will put the model parameters (model weight, gradient and other information) on chain through blockchain, and conduct security audit, such as anomaly monitoring, on local gradients uploaded by the participants through smart contracts, and discard those suspicious model parameters. After passing the security audit, a blockchain consensus algorithm is run to generate multiple sub-model blocks.

Next, the blockchain network or the federated learning network performs sub-model block aggregation operation to form a global model, which can include the following two manners:
1) The blockchain network performs computation to form a global model block. Select a blockchain node among the blockchain nodes and assign the role of “coordinator” to it (for example, rotation system or voting system for selection of each blockchain node), the coordinator is responsible for aggregating and storing sub-model blocks, and updating the global model block. Then, broadcast to the whole network to notify all participants that the block aggregation has been completed, and each federated learning participant downloads the global model block, iteratively optimizes its own model parameters and updates the local model.
2) The federated learning network performs computation to form a global model. (a) Select a “coordinator” among the participants (for example, the coordinator can be the initiator), and the coordinator downloads and aggregates a plurality of sub-model blocks locally to form a global model, and distributes the global model to all participants, who perform their own iterative optimization of model parameters and update the local model; (b) Each participant downloads and aggregates a plurality of sub-model blocks locally to form a global model, performs iterative optimization of their own model parameters, and updates the local model. In this process, the interaction and computation processes participated by federated learning participants are deposited in the blockchain, are stored permanently and cannot be tampered with. In particular, the interaction between federated learning participants and the blockchain, the computation of model blocks, and the records of transactions (model interaction records) among federated learning participants can be recorded in the blockchain by using the blockchain transaction deposit mechanism.

Then it can be judged whether the model parameters of each participant converge, and if so, the model training cycle would be stopped. Otherwise, the previous steps can be cyclically performed to iteratively perform federated learning model training. In one implementation, participant model training can be performed iteratively, such as steps 7-9, in which the participants are basically the same in each iteration, in another implementation, participant confirmation and model training can be performed iteratively, such as steps 5-9, in which the intention nodes can be basically the same in each iteration, in yet another implementation, the confirmation of intention parties, the confirmation of participants and the model training can even be performed iteratively, such as steps 4-9, in which, at the beginning of each iteration, the intention party would be re-determined and then the subsequent operations are performed. In yet another implementation, even step 1-step 9 can be cycled in sequence, wherein each iteration starts from the initiation of federated learning.

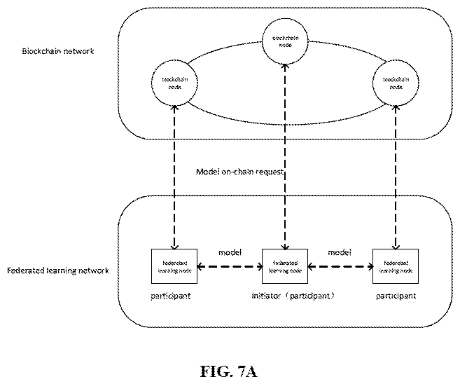

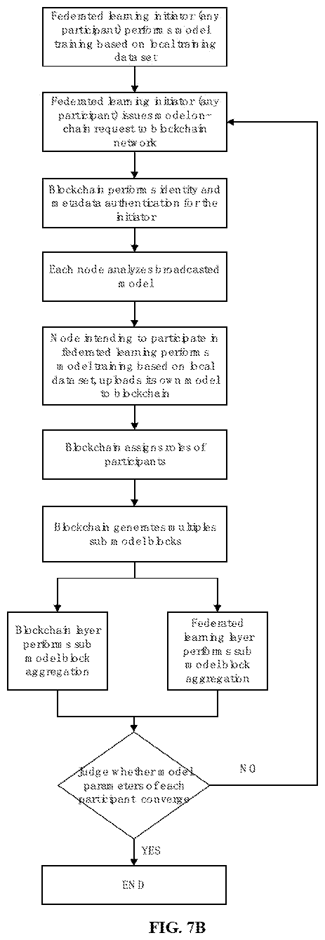

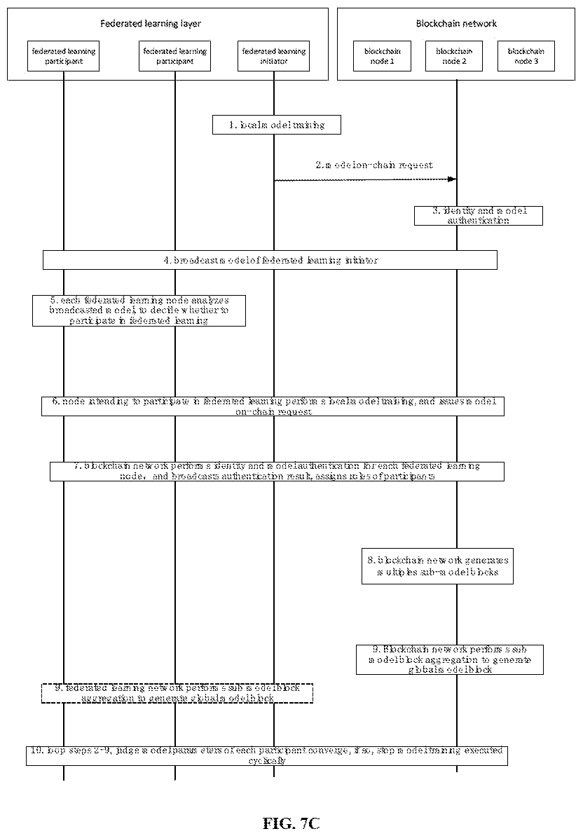

An exemplary implementation of blockchain-based federated learning according to a second embodiment of the present disclosure will be described below with reference to FIGS. 7A-7C. Among them, the participants in the federated learning are not blockchain nodes, and each participant node will conduct federated learning based on blockchain through the interconnection between the federated learning network and the blockchain network, access the blockchain based on model parameters, and perform operations in the federated learning process. The model parameters here can include information such as model weight and gradient, as mentioned above.

First, the federated learning node issues a model on-chain request (step 1-2). In particular, the federated learning initiator (any participant) conducts model training based on the local training data set, and issues a model on-chain request to the blockchain network.

Then, the blockchain node performs verification (identity authentication and information authentication) (step 3-4). In particular, the blockchain first performs identity authentication on the federated learning initiator (participant), and after the identity authentication is successful, verifies legitimacy of model parameters, for example, whether there are suspicious models. After the verification is successful, the blockchain network accepts the request of the initiator, otherwise the request is rejected. Then, the blockchain broadcasts the model of the federated learning initiator to the whole network.

Then, the blockchain node determines the roles of the participants (step 5-7).

Each federated learning node monitors the broadcast of the blockchain, downloads the model of the federated learning initiator, and analyzes whether the model parameters are valid for itself, for example, feature similarity or sample ID alignment, to decide whether to participate in federated learning.

Further, the nodes intending to join federated learning conduct model training based on local data sets and upload their own models to the blockchain.

Then, the blockchain verifies the identities and models of the nodes that intend to join the federated learning to decide whether to agree with the federated learning requests, and broadcasts the verification results throughout the network, and assigns the roles of participants.

Next, the blockchain network or the federated learning network calculates the global model (Step 8-10). Through blockchain, the abnormalities of models uploaded by the participants are monitored through smart contracts and those suspicious models are discarded. By means of the blockchain consensus algorithm, multiple sub-model blocks are generated. Then the blockchain network or the federated learning network performs the sub-model block aggregation operation to form a global model. Here, the computation of the global model can be performed in a way as in the first embodiment described above, and will not be described in detail here.

The federated learning model training of this embodiment can be performed iteratively. Then it can be judged whether the model parameters of each participant converge, and if so, the model training cycle would be stopped. Otherwise, the previous steps can be cyclically performed to iteratively perform federated learning model training. In particular, it can be carried out as in the first embodiment, for example, the participants remain basically unchanged during the iteration, such as step 8-9, or the intention parties remain basically unchanged and the iteration starts from the allocation of participants, such as step 6-9, or the iteration starts the iteration from the determination of the intention parties, such as step 5-9, or even the iteration starts from the initiation of federated learning, such as step 1-9.

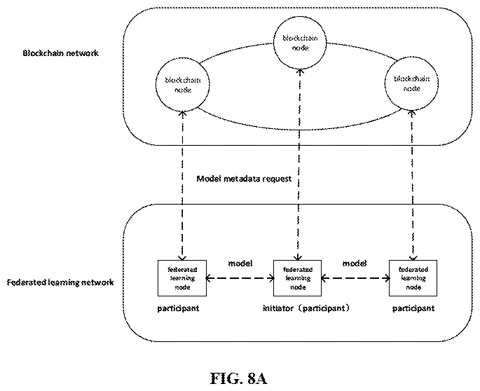

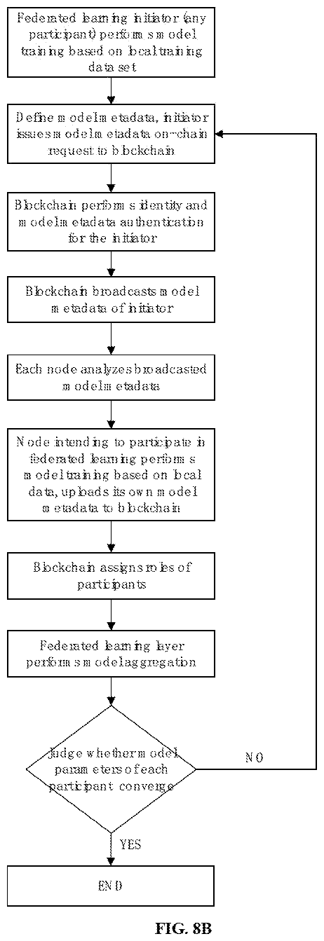

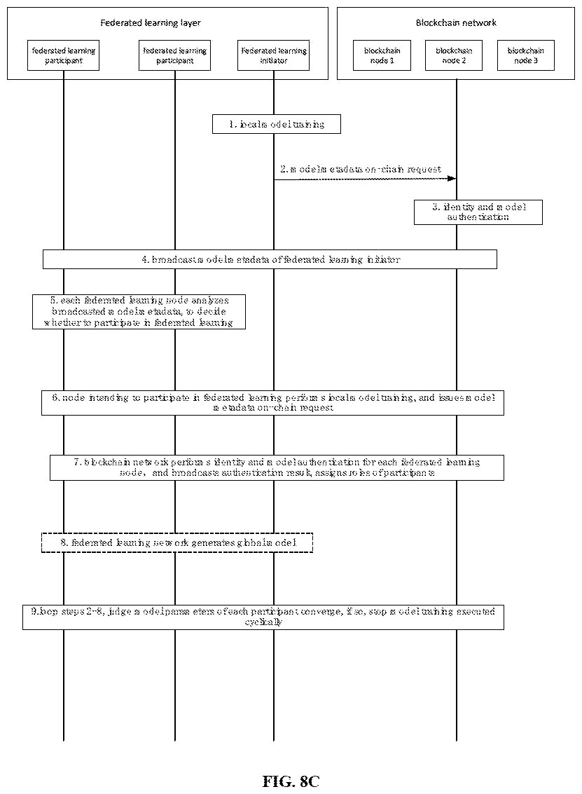

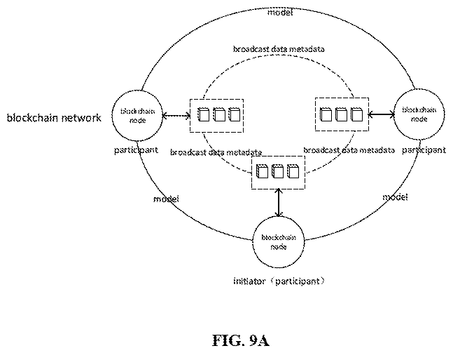

An exemplary implementation of blockchain-based federated learning according to a third embodiment of the present disclosure will be described below with reference to FIGS. 8A-8C. Among them, the participants in the federated learning are not blockchain nodes, and each participant node will conduct federated learning based on blockchain through the interconnection between the federated learning network and the blockchain network, and access the blockchain based on model metadata parameters. The operation flow in this embodiment is as follows.

First, the federated learning node issues a model metadata on-chain request (step 1-2). The initiator of federated learning (any participant) completes local model training based on local data. Then the model metadata is defined, and the initiator issues a model metadata on-chain request to the blockchain.

Next, the blockchain node performs verification (identity authentication and information authentication) (step 3-4). In particular, the blockchain first performs identity authentication on the initiators (participants) of federated learning, and then verifies the model metadata after successful identity authentication, such as verifying whether there is any abnormal model and whether the model has obvious features. After verification, the blockchain broadcasts the model metadata of the federated learning initiator (any participant) to the whole network.

Then, the roles of the participants are determined through a blockchain network (steps 5-7). In particular, each federated learning node monitors the broadcast of blockchain, downloads model metadata, and analyzes the broadcasted model metadata, for example, analyzing feature similarity or data ID alignment, to decide whether to participate in federated learning. Then, a node intending to join the federated learning conducts model training based on local data, and uploads its own model metadata to the blockchain to issue the model metadata on-chain request. Upon receipt of the model metadata request, the blockchain verifies the identity and model metadata of the node intending to join the federated learning, to decide whether to agree with the federated learning request, and broadcast the verification result in the whole network, and assign the participant roles.

Then, a global model is calculated in the federated learning network (steps 7-10). In particular, a coordinator is selected from the participants (for example, the coordinator can be regarded as the initiator), and each participant transmits the local parameter model to the coordinator, and the coordinator aggregates the local models transmitted by each participant to form a global model, and the coordinator distributes the global model to each participant, which performs iterative optimization of own model parameters and updates the local model. Alternatively, each participant can acquire the model parameters of other participants, for example, acquire the model of each participant, so as to aggregate them into the global model locally, iteratively optimize its own model parameters, and update the local model.

In this process, the interaction and computation processes participated by federated learning participants are deposited in the blockchain, are stored permanently, and cannot be tampered with. In particular, signaling interaction between federated learning participants and blockchain, model parameter computation and transaction records (model interaction records) between federated learning participants can all be recorded in blockchain by using blockchain transaction depository mechanism. In particular, each participant has address information, so the interaction between participants can be deposited in the blockchain.

The federated learning model training of this embodiment can be performed iteratively. Then it can be judged whether the model parameters of each participant converge, and if so, the model training cycle is stopped. Otherwise, the previous steps can be cyclically executed to iteratively perform federated learning model training. For example, the iteration can be similarly performed for different stages as in the previous embodiment.

On the other hand, according to the integration of blockchain technology and federated learning technology, in the second type of architecture where federated learning participants are blockchain nodes, federated learning nodes will be used as blockchain nodes in the blockchain for federated learning. In this case, the blockchain will still verify a node that initiates the federated learning and a node that requests to participate in the federated learning, so as to ensure that the federated learning can be carried out safely and reliably, especially the nodes that participate in the federated learning are relatively reliable, in the case that the federated learning participant nodes perform federated learning in the blockchain as blockchain nodes, the communication between the federated learning nodes in the blockchain can be carried out in various appropriate ways, for example, by broadcasting. The above three on-chain operations will be described in detail below with reference to the fourth to sixth embodiments.

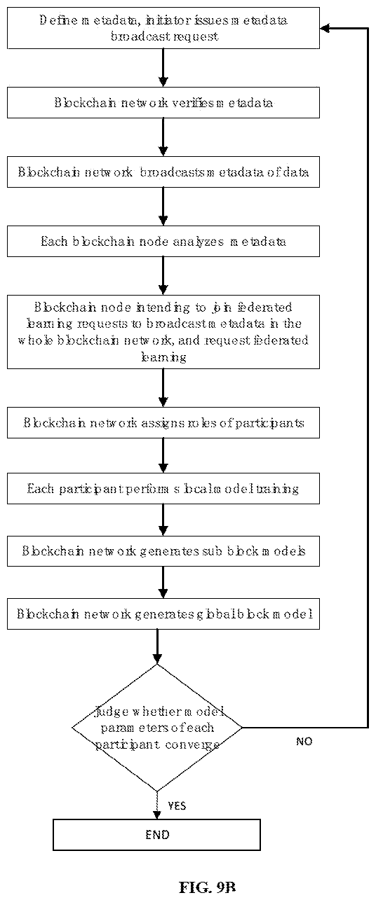

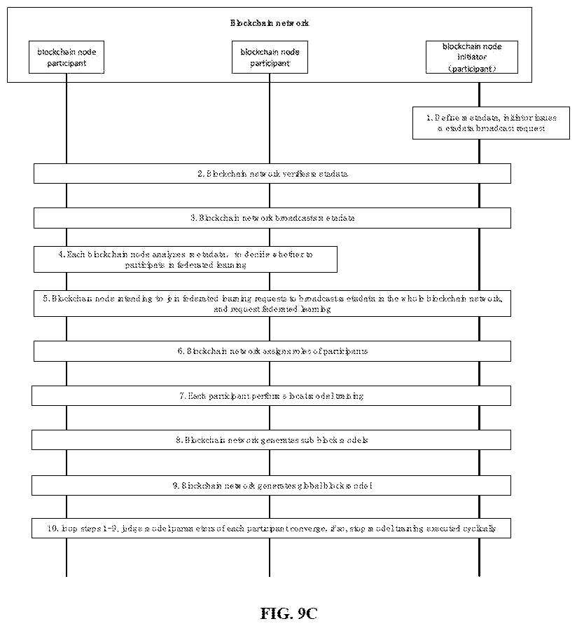

An exemplary implementation of blockchain-based federated learning according to a fourth embodiment of the present disclosure will be described below with reference to FIGS. 9A-9C. Among them, the participants of federated learning are blockchain nodes, and each participant node will conduct federated learning based on blockchain in the blockchain network, and perform federated learning by broadcasting in the blockchain based on metadata.

The detailed workflow is as follows:

First, the blockchain node issues a request of broadcasting metadata of data (step 1). In particular, the initiator of federated learning (any participant) issues a metadata broadcast request, while the actual data of users is still stored in the initiator.

Next, the blockchain network performs verification (information authentication) (step 2-3). In particular, the blockchain network verifies the metadata, for example, checks the field list, sample amount, missing ratio and whether the data is discrete, after the verification is successful, the broadcast is successful, otherwise, the broadcast is rejected. Furthermore, the blockchain broadcasts the metadata of data of the initiator to the whole network.

Next, the blockchain network determines the roles of the participants (step 4-6). In particular, each blockchain node analyzes the metadata to monitor the broadcasted information, and performs analysis based on its local data and the broadcasted metadata, for example, feature similarity or sample ID alignment, to decide whether to participate in federated learning. The blockchain nodes that intend to join the federated learning broadcast the metadata throughout the whole blockchain network for requesting the federated learning. Then, the blockchain side performs metadata verification for the blockchain nodes that intend to join the federated learning, for example, checks the field list, sample amount, missing ratio and whether the data is discrete, to decide whether to agree with the federated learning request, and broadcast the verification results throughout the network, and assign the roles of participants.

Next, the blockchain network computes a global model (step 7-10). In particular, the initiator of federated learning (any blockchain node) and the participants of federated learning conduct model training based on local data sets. Then, through the intelligent contract algorithm, the blockchain network monitors the model anomalies among all federated learning participants, such as abandoning those suspicious data models, and then generates sub-block models through the consensus mechanism among clients. Then, a coordinator is selected from the blockchain nodes (for example, by rotating selection mechanism or voting selection mechanism) and is responsible for aggregating sub-block models to form a global block model, the coordinator distributes the global block model to each participant, which can iteratively optimize its own model parameters, and updates the local model.

The federated learning model training of this embodiment can be performed iteratively. Then it can be judged whether the model parameters of each participant converge, and if so, the model training cycle is stopped. Otherwise, the previous steps can be cyclically executed to iteratively perform federated learning model training. For example, the iteration can be performed for different stages as in the previous embodiment, which will not be described here.

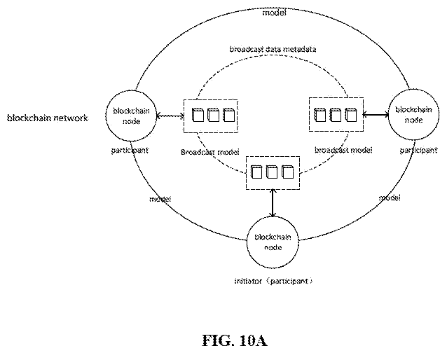

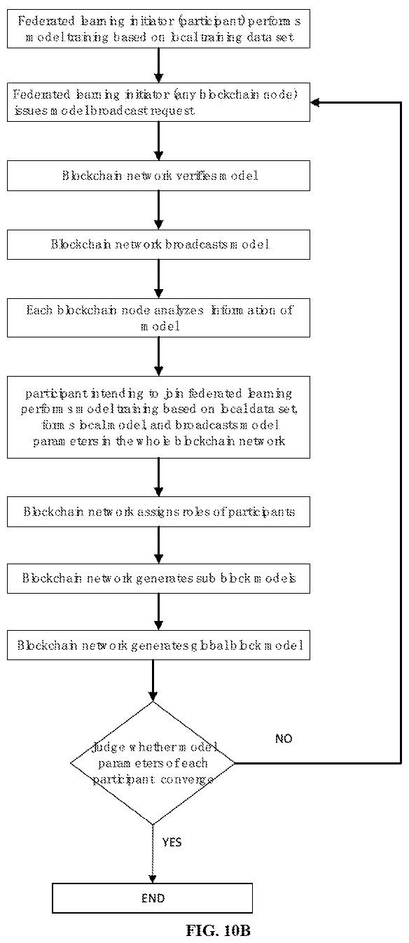

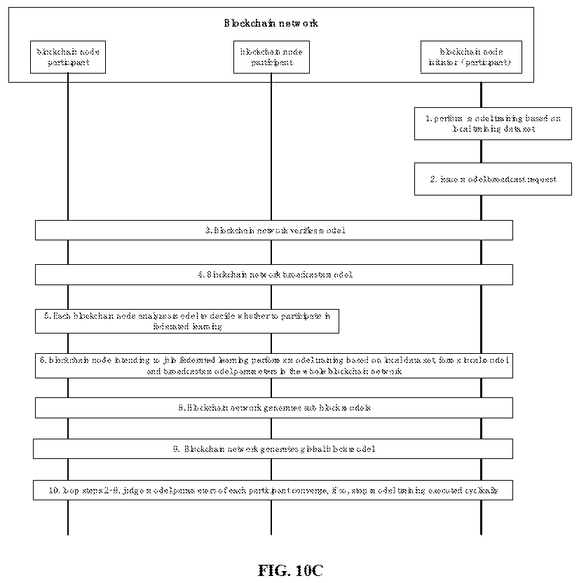

An exemplary implementation of blockchain-based federated learning according to a fifth embodiment of the present disclosure will be described below with reference to FIGS. 10A-10C. Among them, the participants of federated learning are blockchain nodes, and each participant node will conduct the blockchain-based federated learning in the blockchain network, and perform broadcasting in the blockchain based on model parameters for performing federated learning.

First, the blockchain node issues a request of broadcasting model (step 1-2). In particular, the initiator of federated learning (any participant) conducts model training based on local training data sets. Federated learning initiator (any participant) initiates the model broadcast request.

Then, the blockchain network performs verification (information authentication) (step 3-4). The blockchain network verifies the model (for example, to see if there is a suspicious model). After the verification is successful, the broadcast is successful, otherwise the broadcast is rejected. The blockchain network broadcasts the model information of the initiator.

Then, the blockchain network determines the roles of the participants (steps 5-7). Each blockchain node monitors the broadcast of the blockchain, acquires the model parameters of the initiator (participant) of the federated learning, and checks whether the model parameters are valid for itself, such as feature similarity or sample ID alignment, to decide whether to participate in the federated learning. Blockchain nodes intending to join federated learning use local data sets for model training, form the local model, and broadcast model parameters throughout the whole network. The blockchain network verifies the model of the blockchain node that intends to join the federated learning (for example, check whether there is a suspicious model) to decide whether to agree with the federated learning request, and broadcast the verification results throughout the network to assign participants' roles.

Then, the blockchain network computes the global model (step 8-10). In particular, the blockchain network generates the sub-block models, and then the blockchain network forms the global block model. A similar implementation as described above can be adopted here, and will not be described in detail here.

The federated learning model training of this embodiment can be performed iteratively. Then it can be judged whether the model parameters of each participant converge, and if so, the model training cycle is stopped. Otherwise, the previous steps can be cyclically executed to iteratively perform federated learning model training. For example, the iteration can be performed for different stages as in the previous embodiment, which will not be described here.

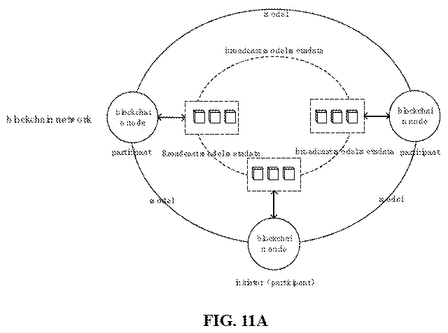

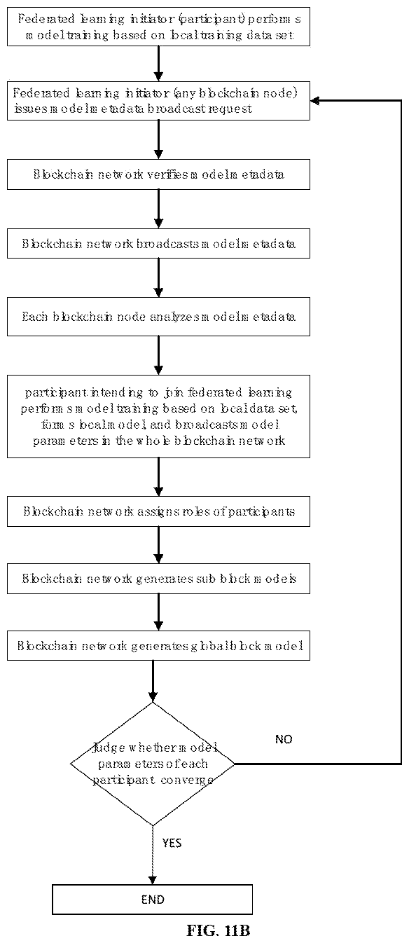

An exemplary implementation of blockchain-based federated learning according to a sixth embodiment of the present disclosure will be described below with reference to FIGS. 11A-11C. Among them, the participants of federated learning are blockchain nodes, and each participant node will conduct the blockchain-based federated learning in the blockchain network, and perform broadcasting in the blockchain based on model metadata parameters for performing federated learning.

First, the blockchain node issues a request of broadcasting model metadata (step 1-2). In particular, the initiator of federated learning (any participant) conducts model training based on local training data sets. The model metadata is defined, and the federated learning initiator (any participant) initiates the model broadcast request.

Then, the blockchain network performs verification (information authentication) (steps 3-4). The blockchain network verifies the model metadata (for example, whether the amount of samples is sufficient, or whether there are obvious model features). After the verification is successful, the broadcast is successful, otherwise it will be rejected. The blockchain network broadcasts the model metadata of the initiator.

Then, the blockchain network determines the roles of the participants (steps 5-7). Each blockchain node monitors the broadcast of the blockchain, acquires the model metadata of the initiator (participant) of the federated learning, and checks whether the model metadata is valid for itself, such as feature similarity or sample ID alignment, to decide whether to participate in the federated learning. Blockchain nodes intending to join federated learning use local data sets for model training, form the local model, and broadcast model metadata throughout the whole network. The blockchain network verifies the model metadata of the blockchain nodes that intend to join the federated learning (for example, check whether the amount of samples is sufficient, or whether there are obvious model characteristics) to decide whether to agree with the federated learning request, broadcast the verification results throughout the network, and assign participants' roles.

Then, the blockchain network computes the global model (step 8-10). In particular, the blockchain network generates the sub-block models, and then the blockchain network forms the global block model. A similar implementation as described above can be adopted here, and will not be described in detail here.

The federated learning model training of this embodiment can be performed iteratively. Then it can be judged whether the model metadata of each participant converge, and if so, the model training cycle is stopped. Otherwise, the previous steps can be cyclically executed to iteratively perform federated learning model training. For example, the iteration can be performed for different stages as in the previous embodiment, which will not be described here.

It should be noted that the above description is only exemplary. The embodiments of the present disclosure can also be executed in any other appropriate manner, and the advantageous effects obtained by the embodiments of the present disclosure can still be achieved. Moreover, the embodiments of the present disclosure can also be applied to other similar application examples, and the advantageous effects obtained by the embodiments of the present disclosure can still be achieved. It should be understood that machine-executable instructions in the machine-readable storage medium or program product according to the embodiments of the present disclosure may be configured to perform operations corresponding to the above-mentioned device and method embodiments. When referring to the above embodiments of the device and method, the embodiments of the machine-readable storage medium or the program product are obvious for those skilled in the art, and therefore will not be described repeatedly. Machine-readable storage media and program products for carrying or including the aforementioned machine-executable instructions also fall within the scope of the present disclosure. Such a storage medium may include, but not limited to, a floppy disk, an optical disk, a magneto-optical disk, a memory card, a memory stick, and the like.

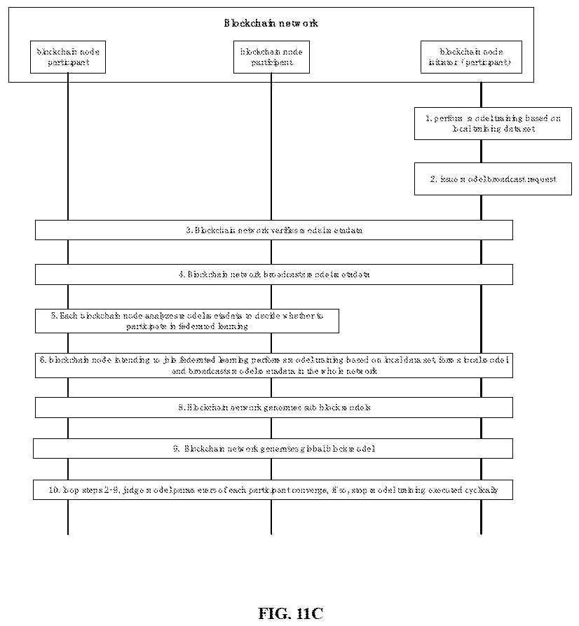

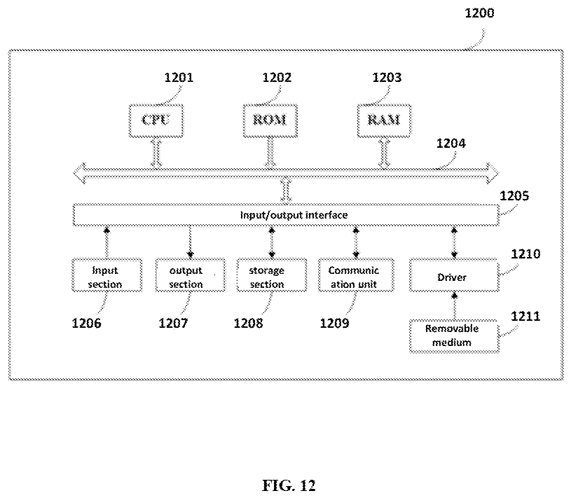

In addition, it should be understood that the series of processes and devices as described above may also be implemented by software and/or firmware. In the case of being implemented by software and/or firmware, a corresponding program constituting the corresponding software is stored in a storage medium of the related device, and when the program is executed, various functions can be achieved. As an example, a program constituting the software can be installed from a storage medium or a network to a computer having a dedicated hardware structure, such as a general-purpose computer 1200 shown in FIG. 12, and the computer is capable of executing various functions and so on when various programs are installed. FIG. 12 is a block diagram showing an exemplary structure of a computer as an example of an information processing apparatus that can be employed in an embodiment according to the present disclosure. In one example, the computer may correspond to the above-described exemplary electronic device on the blockchain side or the electronic device on the federated learning side according to the present disclosure.

In FIG. 12, a central processing unit (CPU) 1201 performs various processes according to a program stored in a read only memory (ROM) 1202 or a program loaded from a storage section 1208 to a random-access memory (RAM) 1203. In the RAM 1203, data required when the CPU 1201 executes various processes and the like is also stored as necessary.

The CPU 1201, the ROM 1202, and the RAM 1203 are connected to each other via a bus 1204. An input/output interface 1205 is also connected to the bus 1204.

The following components are connected to the input/output interface 1205: the input section 1206 including a keyboard, a mouse, etc.; the output section 1207 including a display, such as a cathode ray tube (CRT), a liquid crystal display (LCD), etc. and a speaker, etc.; the storage section 1208 including hard disks, etc.; and communication section 1209 including network interface cards such as LAN cards, modems, etc. The communication section 1209 performs communication processing via a network such as the Internet.

The driver 1210 can also be connected to the input/output interface 1205 as needed. The removable medium 1211 such as a magnetic disk, an optical disk, a magneto-optical disk, a semiconductor memory, etc. is installed on the driver 1210 as needed, so that a computer program read out therefrom is installed into the storage section 1208 as needed.

In the case where the above-mentioned series of processing is realized by software, a program constituting the software is installed from a network such as the Internet or a storage medium such as a removable medium 1211.

Those skilled in the art should understand that a storage medium is not limited to the removable medium 1211 shown in FIG. 12 in which the program is stored and which is distributed separately from the device to provide the program to the user. Examples of removable media 1211 include magnetic disks (including floppy disks), optical disks (including CD-ROMs and digital versatile disks (DVDs)), magneto-optical disks (including mini disks (MD) (TM)) and semiconductor memory. Alternatively, the storage medium may be ROM 1202, a hard disk included in the storage portion 1208, and the like, in which programs are stored, and are distributed to users along with the device containing them.

In addition, it should be understood that multiple functions included in one unit in the above embodiments may be implemented by separate devices. Alternatively, multiple functions implemented by multiple units in the above embodiments may be implemented by separate devices, respectively. In addition, one of the above functions can be implemented by multiple units. Needless to say, such configuration is included in the technical scope of the present disclosure.

Herein, the steps illustrated in the flowchart include not only processes performed in the described order in time series, but also processes performed in parallel or individually instead of having to be performed in time series. Further, even in the steps processed in time series, needless to say, the order can be appropriately changed.

Although the present disclosure and its advantages have been described in detail, it should be understood that various changes, substitutions and alterations can be made hereto without departing from the spirit and scope of the present disclosure as defined by the appended claims. Moreover, the terms “including”, “comprising”, or any other variation thereof, in the embodiments of the present disclosure are intended to cover non-exclusive inclusion, so that a process, method, article, or device that includes a series of elements includes not only those elements, but includes other elements not explicitly listed, or also elements inherent to such a process, method, article, or device. Without more restrictions, the elements defined by the sentence “including a . . . ” do not exclude a case that in the process, method, article, or device that includes the elements, other identical elements exist.

Although some specific embodiments of the present disclosure have been described in detail, those skilled in the art should understand that the above embodiments are merely illustrative and do not limit the scope of the present disclosure. Those skilled in the art should understand that the above embodiments may be combined, modified, or replaced without departing from the scope and essence of the present disclosure.

1. An electronic device for blockchain-based federated learning, comprising a processing circuit configured to:
acquire first federated learning related information from a federated learning node,
cause verifying whether the federated learning node is able to participate in federated learning based on the first federated learning related information through blockchain, and
notify the federated learning side of indication information indicating federated learning nodes that are able to participate in federated learning, so that the indicated federated learning nodes that are able to participate in federated learning are able to perform data processing based on federated learning.

2. The electronic device of claim 1, wherein the processing circuit is further configured to:
cause verifying whether the first federated learning related information meets a federated learning requirement through blockchain; and
confirm that the federated learning node is able to participate in federated learning under the condition that the first federated learning related information meets the federated learning requirement.

3. (canceled)

4. The electronic device of claim 1, wherein the processing circuit is further configured to
acquire model parameters from federated learning participant nodes on the federated learning side,
cause generation of model blocks based on the model parameters from the federated learning participant nodes through blockchain, and
notify the generation of model blocks to the federated learning side, so that federated learning participant nodes are able to optimize model parameters based on the model blocks,
wherein the model blocks comprise one of sub model blocks and a global model block generated based on the sub model blocks.

5. (canceled)

6. (canceled)

7. The electronic device of claim 4, wherein the processing circuit is further configured to:
generate sub-model blocks based on model parameters from federated learning participant nodes through blockchain, and
cause aggregation of the generated sub-model blocks through a blockchain technique to generate a global model block.

8. The electronic device of claim 1, wherein the processing circuit is further configured to:
acquire third federated learning related information from the federated learning nodes,
cause verifying whether to initiate execution of federated learning through blockchain based on the third federated learning related information through blockchain; and
transmit at least one part of the third federated learning related information to the federated learning side, in a case that it is verified that federated learning through blockchain is able to be initiated,
wherein the third federated learning related information is at least partially the same type as information contained in the first federated learning related information.

9. (canceled)

10. The electronic device of claim 1, wherein the first federated learning related information includes at least one of identity information, data metadata information, model parameter information and model metadata information of the federated learning node, wherein,
the data metadata information includes at least one of data attribute information, data structure information and data distribution information; and/or
the model parameter information includes at least one of model type, model weight and model gradient; and/or
the model metadata information includes at least one of an identifier of a federated learning participant node, a model type, the amount of local training samples, local model training accuracy, and the federated learning participation status information.

11. (canceled)

12. (canceled)

13. The electronic device of claim 1, wherein at least one of the federated learning nodes belongs to a node in the blockchain side.

14. An electronic device for blockchain-based federated learning, comprising a processing circuit configured to:
transmit first federated learning related information to a blockchain side,
acquire indication information from the blockchain side indicating whether a federated learning node associated with the electronic device is able to participate in federated learning, wherein the indication information is generated by verifying the first federated learning related information through blockchain; and
under the condition that it is determined that the federated learning node associated with the electronic device is able to participate in federated learning based on the indication information, cause data processing by federated learning nodes on the federated learning side that are able to participate in the federated learning in combination based on federated learning.

15. The electronic device of claim 14, wherein the processing circuit is further configured to:
acquire global model parameters, which are generated based on model parameters of federated learning nodes on the federated learning side that are able to participate in federated learning; and
perform model optimization based on the global model parameters.

16. The electronic device of claim 14, wherein the processing circuit is further configured to:
acquire model parameters of federated learning nodes on the federated learning side that are able to participate in federated learning,
generate global model parameters by aggregating the model parameters of federated learning nodes, and
transmit the global model parameters to each federated learning node.

17. The electronic device of claim 14, wherein the processing circuit is further configured to:
transmit model parameters acquired by the federated learning node through local model training, and
acquire a global model block, which is generated based on model parameters of federated learning nodes on the federated learning side that are able to participate in the federated learning through blockchain; and
perform local model optimization based on the global model block.

18. The electronic device of claim 14, wherein the processing circuit is further configured to:
acquire sub-model blocks generated based on model parameters of federated learning nodes through blockchain; and
aggregate the acquired sub-model blocks into a global model block.

19. The electronic device of claim 18, wherein the processing circuit is further configured to:
distribute the global model block to other federated learning nodes that are able to participate in federated learning.

20. The electronic device of claim 14, wherein the processing circuit is further configured to:
acquire second federated learning related information,
verify whether local federated learning related information matches the acquired second federated learning related information; and
in the case of matching, determine that the federated learning node associated with the electronic device intends to participate in federated learning.

21. The electronic device of claim 14, wherein the processing circuit is further configured to:
transmit a federated learning initiation request to the blockchain side, wherein the federated learning initiation request includes third federated learning related information; and
acquire information indicating whether the blockchain-based federated learning is allowed to be initiated, wherein the information is generated by verifying the third federated learning related information through blockchain.

22. (canceled)

23. The electronic device of claim 14, wherein the processing circuit is configured to:
verify whether model parameters meet a specific convergence condition, and
perform the blockchain-based federated learning iteratively, if the model parameters cannot meet the specific convergence condition.

24. (canceled)

25. A method of blockchain-based federated learning, which is executed in a blockchain-based federated learning system including a federated learning side and a blockchain side, the method comprises:
transmitting first federated learning related information associated with federated learning nodes from the federated learning side to the blockchain side,
receiving the first federated learning related information, and verifying whether the federated learning nodes are able to participate in federated learning based on the first federated learning related information through blockchain, by the blockchain side,
notifying the federated learning side of indication information indicating federated learning participant nodes that are able to participate in federated learning, by the blockchain side,
determining, by the federated learning side, federated learning participant nodes based on the indication information, and
performing data processing by the federated learning nodes on the federated learning side that able to participate in federated learning based on federated learning.

26. The method of claim 25, further comprising:
transmitting third federated learning related information by a federated learning node on the federated learning side to the blockchain side,
verifying, by the blockchain side, whether the federated learning is allowed to initiate based on the third federated learning related information, and transmitting second federated learning related information to the federated learning side if the federated learning is allowed to initiate, wherein the second federated learning related information is at least a part of the third federated learning related information,
judging, by each federated learning node on the federated learning side, whether the federated learning node intends to participate in federated learning based on the second federated learning related information.

27. The method of claim 25, further comprising:
transmitting model parameters of each federated learning node that is allowed to participate in federated learning by the federated learning side to the blockchain side,
generating a model block by the blockchain side based on the model parameters of each federated learning node,
notifying the federated learning side of the generation of the model block by the blockchain side; and
performing local model optimization by each federated learning node on the federated learning side based on the model block,
wherein the model block comprises one of sub-model blocks and a global model block generated based on the sub model blocks.

28. (canceled)

29. The method of claim 25, further comprising:
generating global model parameters on the federated learning side based on model parameters of federated learning nodes on the federated learning side that are allowed to participate in federated learning, and
performing local model optimization by each federated learning node on the federated learning side based on the global model parameters.

30.-35. (canceled)
